(19) United States
(12) Patent Application Publication
(10) Pub. No.: US 2014/0114706 A1
(43) Pub. Date: Apr. 24, 2014

(54) SYSTEM AND METHOD FOR AN AUTOMATED CONCIERGE

(71) Applicant: John Ford Blakely, Del Mar, CA (US)

(72) Inventor: John Ford Blakely, Del Mar, CA (US)

(21) Appl. No.: 14/144,481

(22) Filed: Dec. 30, 2013

Related U.S. Application Data
(63) Continuation-in-part of application No. 12/624,211, filed on Nov. 23, 2009.
(60) Provisional application No. 61/848,399, filed on Dec. 31, 2012.

(51) Int. Cl. G06Q 10/02

(52) U.S. Cl. CPC G06Q 10/02
USPC 705/5; 705/304

(57) ABSTRACT

A concierge system that coordinates incoming message requests between a wireless device and a merchant computer system having various service departments to fulfill a requested action. The concierge server receives incoming message requests for service from the wireless device. A concierge application is resident on the concierge server, and the concierge application is configured to receive an incoming message from the wireless device for a requested service. In response to the incoming message, a reply message is sent back acknowledging receipt of the incoming message to the wireless device. Simultaneously, the merchant computer system is notified of the incoming message request.

### CROSS REFERENCE TO RELATED APPLICATIONS

This application is a Non-Provisional Application and claims priority to U.S. Provisional Application Ser. No. 61/848,399 filed Dec. 31, 2012; and also claims priority to U.S. Non-Provisional application Ser. No. 12/624,211 filed Nov. 23, 2009, the contents of all of which are hereby incorporated by reference herein in their entirety into this disclosure.

### 1. TECHNICAL FIELD

The instant disclosure relates to a system and method for an automated concierge system, and in particular to an automated messaging platform system that coordinates incoming message requests between a guest mobile device and a merchant computer system with various service departments to fulfill a requested action.

### 2. BACKGROUND

To a merchant, good customer service is key to a successful operation. However, all too frequently a customer's experience may not be so enjoyable and may ultimately become difficult and frustrating due to inordinate wait times before a guest has an opportunity to speak to an individual at the concierge desk to make a request for service.

By way of one example, when a guest arrives at a hotel, the guest has to go through the cumbersome experience of waiting for a person at the front desk to collect their information and check them into the hotel. The inconvenience begins upon arrival, this requires the guest to wait on a valet before they can get out of their vehicle and walk to the front desk counter to check in. Once at the front desk, a guest typically has to wait in another line before they can be helped. More often than not, the line is long and few hotel employees are available to help the guests wanting to check in or out and/or other needs of other hotel service requests.

During the guests stay, the stay could be further frustrated when the guest is in need of a service request and has to call down to the front desk for a simple service request. Unfortunately, that call is all too oftentimes met with an “on-hold” wait until the front desk can pick up the line. Similar problems exist at other customer service oriented establishments that cater to a number of guests at a time.

A longstanding, and more efficient, need to solve this problem at these customer service establishments exists.

### BRIEF DESCRIPTION OF THE DRAWINGS

Various exemplary embodiments of this invention will be described in detail, wherein like reference numerals refer to identical or similar components or steps, with reference to the following figures, wherein:

FIG. 1 illustrates an exemplary illustration of the automated concierge system.

FIG. 2 shows a network block diagram for the automated concierge system (ACS).

FIG. 2A shows a block diagram of the merchant computer system connected to the ACS.

FIG. 2B shows a block diagram of the ACS.

FIG. 3 depicts an end-user communicating an incoming message into the ACS.

FIG. 4 illustrates the various processors in the ACS.

FIG. 5 shows a process flow for an inbound communication processor.

FIG. 6 shows a process flow for a workflow processor.

FIG. 7 depicts a process flow for a device processor.

FIG. 8 illustrates a process flow for an outbound processor.

FIG. 9 shows an exemplary bidirectional communication between a guest mobile device and the ACS.

FIG. 10 depicts a guest check in dash board of the ACS.

FIG. 11 illustrates a self-enrollment dash board of the ACS.

FIGS. 12-13 show the self-enrollment messaging mobile device display.

FIG. 14 depicts a keyword menu reply message from the ACS.

FIG. 15 shows an incoming request dash board of the ACS.

FIG. 16 depicts an inbox dashboard view of various requests in the ACS.

FIGS. 17-18 depict dashboard user interface views for generating a message back to the hotel guest.

FIG. 19 shows the guest registration dashboard user interface.

FIG. 20 illustrates a general settings dashboard pane in the ACS.

FIG. 21 depicts a notifications dashboard pane in the ACS.

FIG. 22 shows a message template dashboard pane in the ACS.

FIG. 23 illustrates wait times configuration dashboard view in the ACS.

FIG. 24 shows a forwards/actions dashboard pane in the ACS.

FIG. 25 depicts a dashboard in which guests list can be imported in the ACS.

FIG. 26 illustrates a tickets dashboard pane in the ACS.

FIG. 27 shows an inbox dashboard view of various messages from a hotel guest in the ACS.

FIG. 28 depicts a message composition dashboard pane view.

FIGS. 29-30 illustrate guest registration dashboard views in the ACS.

FIG. 31 demonstrates adding additional guests to the guest registration dashboard view in the ACS.

FIG. 32 depicts receiving an incoming message from a guest mobile device where the ACS is adapted for use in an auto dealership scenario.

FIG. 33 shows composing a reply customer message in a dashboard view adapted for use in the auto dealership scenario.

FIG. 34 illustrates a registration dashboard view in the auto dealership scenario.

FIG. 35 depicts a registered ticket dashboard view in the auto dealership scenario.

FIG. 36 shows an account options dashboard view in the auto dealership scenario.

FIG. 37 shows an inbox dashboard view in the ACS.

FIG. 38 depicts a survey configuration dashboard view in the ACS.

FIGS. 39-40 illustrate a touchtone dashboard and inbox showing the acknowledgment of the touchtone request by the guest in the ACS.

### DETAILED DESCRIPTION

The subject disclosure is now described with reference to the drawings. In the following description, for purposes of explanation, numerous specific details are set forth in order to provide a thorough understanding of the claimed subject matter. It may be evident, however, that the subject disclosure may be practiced without all of the specific details. In other instances, well-known structures and graphical user interfaces are shown in block diagram form in order to facilitate describing the subject disclosure.

An efficient and attentive concierge makes for a successful customer service experience. According to this subject disclosure, one way to achieve that goal is to dramatically reduce the time with which a guest can make their request and have their request fulfilled with as little disruption to their personal enjoyment of the particular business accommodation. As such, an automated concierge system is provided in which a customer request can be made, and fulfilled, with very little interaction by the guest.

Text messaging is a simple and efficient mode of communication. More specifically, short messaging service (SMS) is a universally accepted messaging protocol that is easy and convenient to compose and send to a recipient having SMS capable devices and systems.

Mobile cell phones are constantly sending and receiving information. The mobile device is talking to its cell phone tower over a pathway called a control channel. The reason for this chatter is so that the cell phone system knows which cell your phone is in, and so that your phone can change cells as the user moves around. Every so often, the mobile phone and the tower will exchange a packet of data that lets both of them know that they are both properly connected. The mobile phone uses the control channel for call setup. When someone tries to call you, the tower sends your phone a message over the control channel that tells your phone to play its ringtone. The tower also gives your phone a pair of voice channel frequencies to use for the call. More importantly, the control channel provides the pathway for SMS messages. When a person sends an SMS message, the message flows through the short message service center (SMSC, network element in the mobile telephone network whose purpose is to store, forward, convert and deliver SMS messages), then to the tower, and the tower sends the message to the mobile phone as a little packet of data on the control channel. In the same way, when an SMS is sent from the mobile phone, the mobile phone sends the SMS to the tower on the control channel and the SMS goes from the tower to the SMSC and from there to its destination. The SMS includes data about the message, such as length of the message, a time stamp, the destination phone number, the sending phone number, etc.

In this technologically advanced age, it requires substantially less time and less network resources to compose and send an SMS than to make and/or hold on a connected real-time path phone call, or to set-up a time consuming WAP session, e-mail or instant message (IM). Conventionally, most messaging applications require a client application to be installed on the guest communication device thereby consuming their available storage and memory. However one advantage of this subject disclosure is to leverage the benefits of SMS, that is, by composing and sending a simple SMS with specific request instructions over an unused control channel to alleviate the requester from being tied to their phone or to their computer (such as with an e-mail and/or a connected IM session) in order to make a request for service.

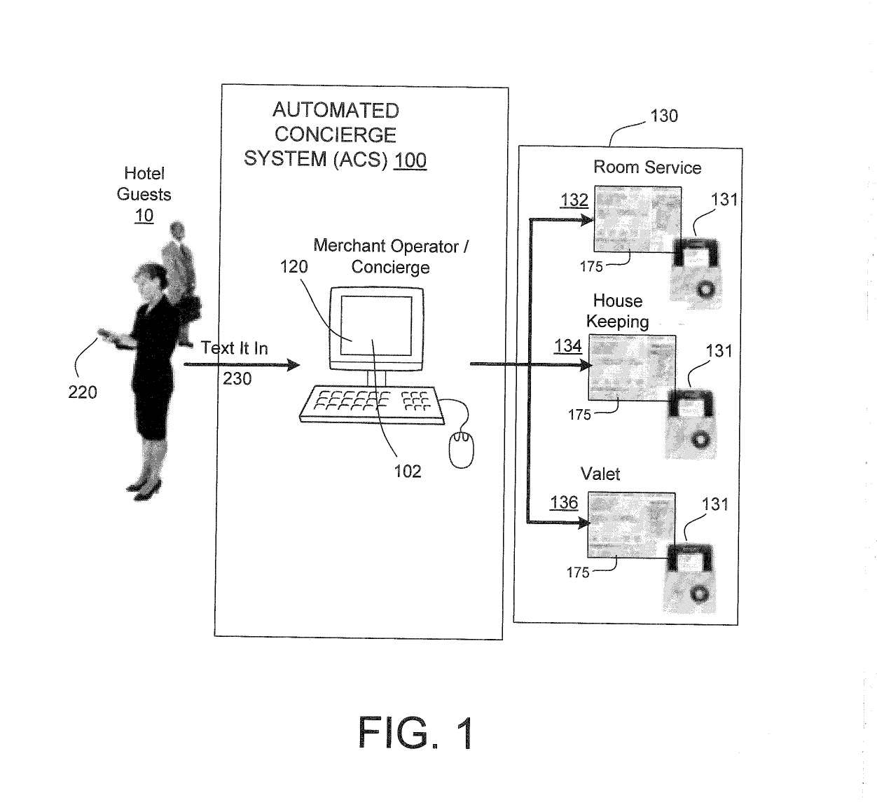

FIG. 1 illustrates a general overview of an exemplary automated concierge system (ACS) 100. The ACS 100 may be a Web-based service having a remote database or cloud storage system and processing taking place on a cloud based remote data server. The communication network 210 provides the connection between the merchant compute system 102 and the ACS 100. The advantage to the ACS 100 being a cloud based system is that the service can be accessed from any location by a merchant having Internet access and a Web browser as the interface software. The ACS 100 service may primarily reside in the back end, and the merchant computer system 102 may reside in the front end and they connect to each other through the communications network 210.

The ACS 100 may include various supporting computers, servers and data storage systems administered by a central server that follows a set of protocols and uses middleware to monitor traffic and client demands to ensure everything operates properly. For exemplary purposes, the ACS 100 may be shown resident on a dedicated server.

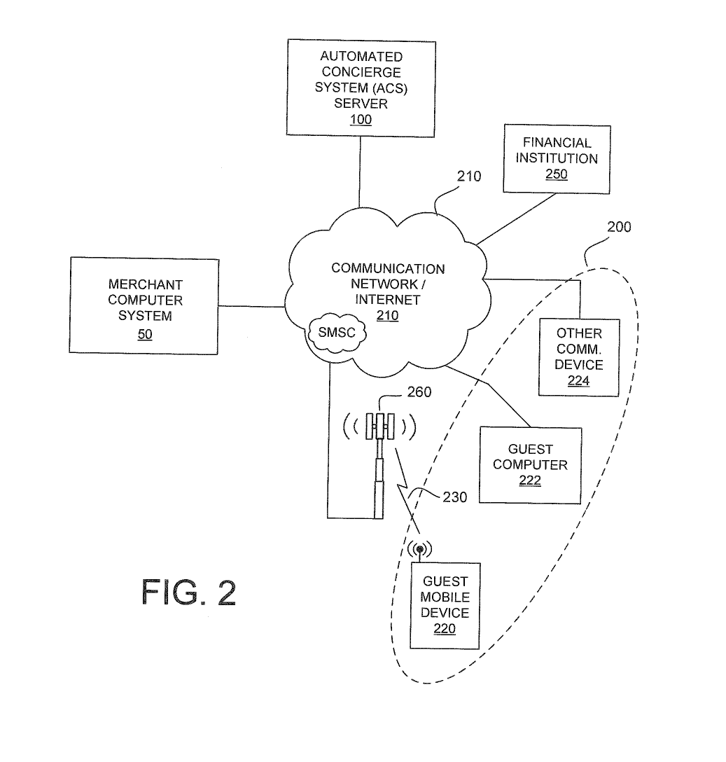

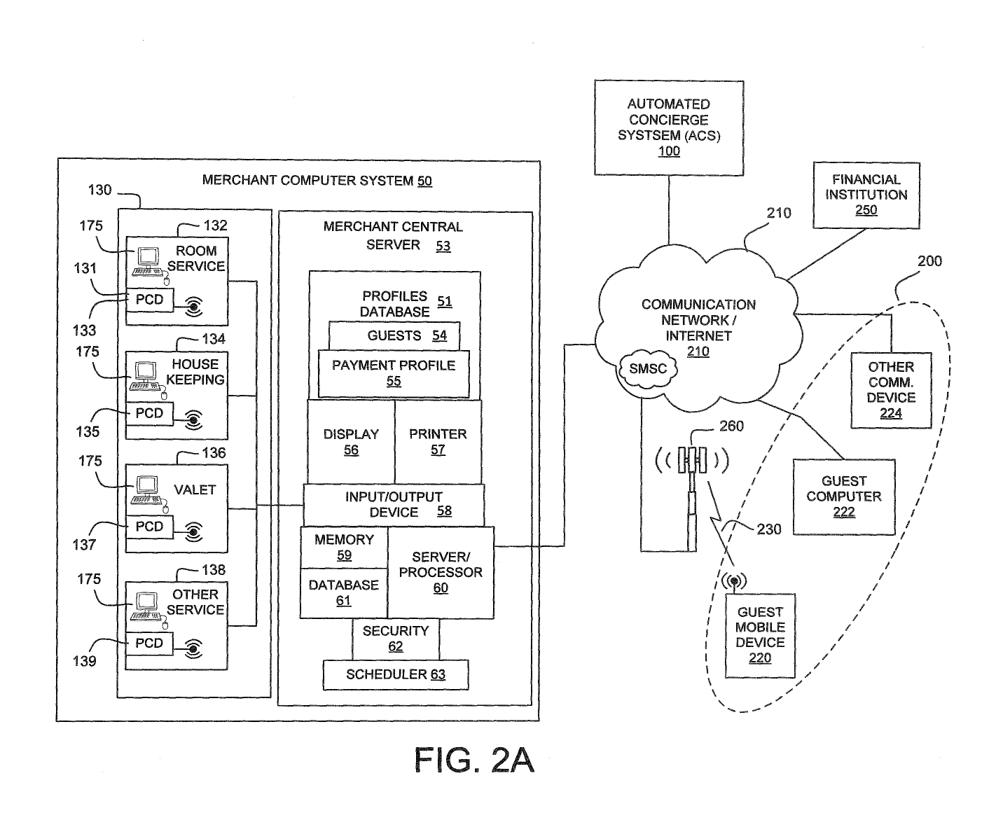

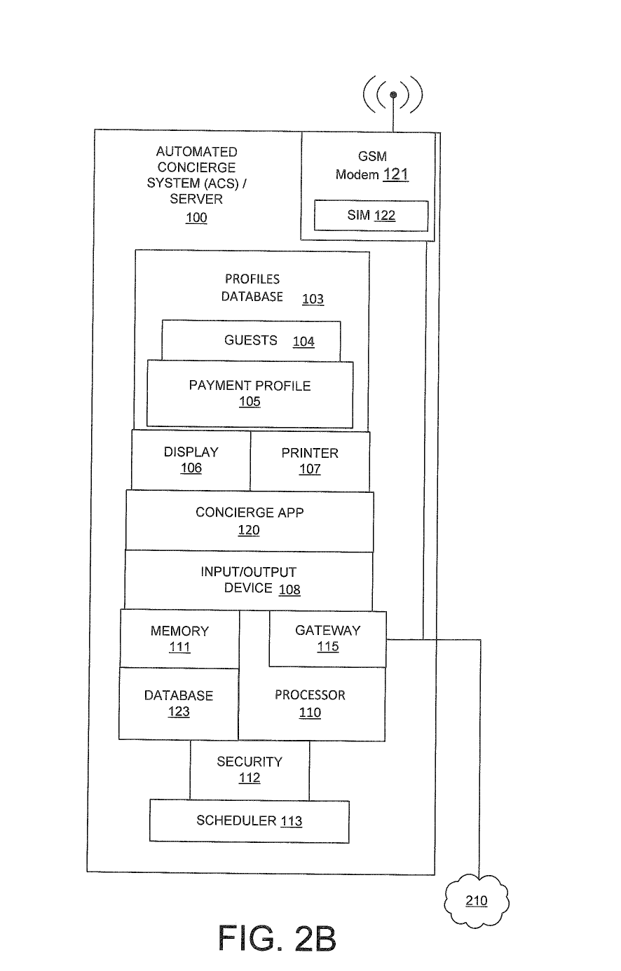

FIG. 2 is a network diagram of the ACS 100 working in communication with a merchant computer system 50, such as a hotel merchant facility. The ACS 100 may be a cloud based system server that can be accessed by the merchant computer system 50 via the communication network 210.

As shown in FIG. 2A, the merchant computer system 50 includes a central computer 53 that is connected to a variety of service departments 130 that provide various services by the merchant business provider. That is, the merchant computer system 50 includes a variety of service departments 130 providing service (such as, Room Service 132, House Keeping 134, Valet 136 or other service 138) in the hotel establishment.

The merchant central computer 53 includes a display 56, printer 57, input/output devices 58 and a processor 60. The processor 60 may be connected to memory 59, possibly a security application 62 and a scheduler 63.

The merchant computer system 50 is capable of storing all customer info in guest specific profiles database 51, including but not limited to, a phone number, address, payment information, vehicle information, preferences, frequent requests, wake-up call times, and other information on their profile. Various profiles for at least the participating guests/customers may be provided in a profiles database 51. The profile information may include various specific information about each of the hotel guests, such as payment profile 55 information.

The merchant computer system 50 can be connected to a financial institution 250 associated with the guest mobile device 220 and/or hotel guest. That is, a hotel guest can associate their mobile device 220 and payment information, such as a credit card, banking information and/or other payment information to their customer payment profile information 105 account to provide payment for their various services via an electronic method, such as a virtual wallet, credit or debit card, hotel gift card, or other convenient method of payment associated with the guests payment profile. The convenience of making a virtual payment will also increase the satisfaction of the hotel customer and the efficiency in which the hotel customer can interact to make payment and be on their way.

FIG. 2B shows a simplified diagram of the ACS 100. The ACS 100 is a server supporting a virtual concierge application 120. The ACS 100 may have various components that mirror the merchant computer system 50. The ACS 100 also includes a processor 110, memory 111, security application 112 and a scheduler 113. The ACS 100 may include a display 106, a printer 107, and input/output devices 108. The ACS 100 may include a protocol translation/mapping gateway 115 and a modem 121 or other software embedded to communicate various types of messaging.

The ACS 100 may also include a calendar and scheduling 113 functionality by which the various incoming message requests 230 are to be coordinated with the hotel staff resources, the guests' available schedule and other various calendar tasks. The ACS 100 can efficiently coordinate and track the various requests to be performed by the hotel staff in an efficient manner. Likewise, the scheduler 113 can be used to define which type of reply message the ACS 100 should return to the guest mobile device 220 based on a particular day or time of day as will be described later.

The ACS 100 can mirror over the various profile databases 103 so that the ACS 100 can obtain pertinent information about the guest 10. Various types of profile information obtained by the ACS 100 may include, but is not limited to, phone numbers, addresses, payment information, valet information, check-in and check-out times, vehicle information, preferences, frequent requests, wake-up call times, and other information on their profile.

In this application, the ACS 100 may be connected via the communication network 210 to the merchant computer system 50 and to information resident at the merchant central server 53 or to the various service departments 130 that provide a hotel service, such as, Room Service 132, House Keeping 134, Valet 136 or other service 138 in the hotel establishment.

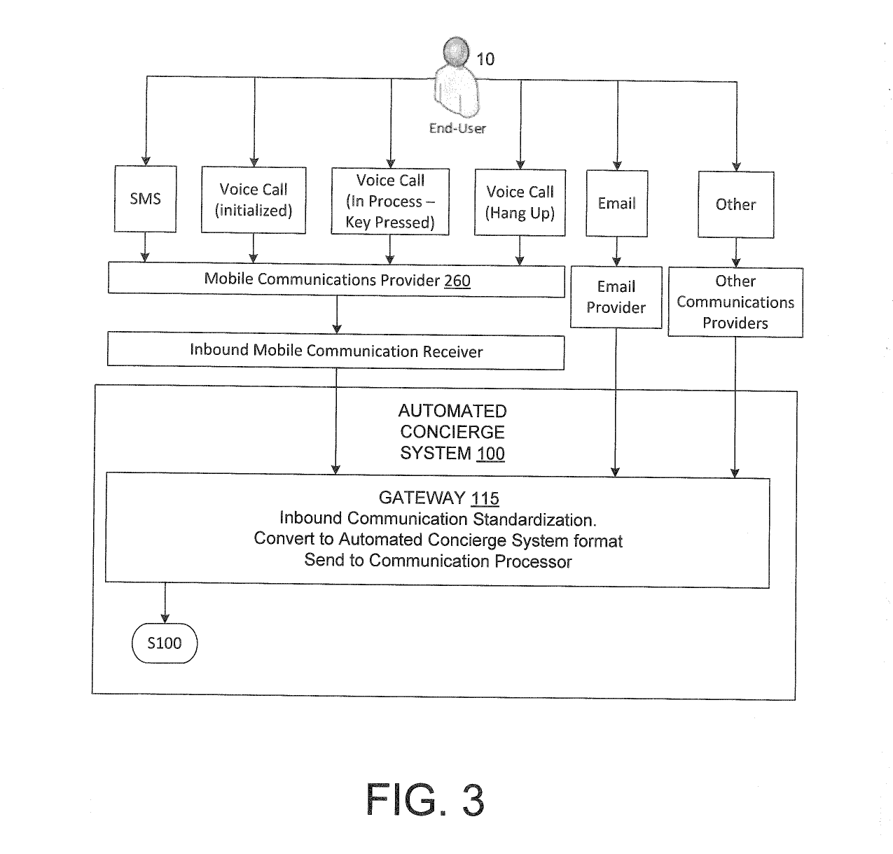

FIGS. 2 and 3 show a customer or guest electronic communication device 200 being utilized by an end-user 10. The end user 10 may communication via a communication network 210 to the ACS 100. The end-user 10 may select from a variety of different modes in which to communicate with the communications network 210, such as by SMS, text, by a voice call. Communication may be activated by the voice call, while in the process of a voice call by pressing specific keys or at the end of the voice call upon hanging up or termination of a voice call a request may be generated and sent over the communications network 210 to the ACS 100. The end-user 10 may use email (such as an IM session) or other communication medium for generating a request message to the ACS 100.

In the event that a guest mobile device 220 is used, a mobile communications provider 260 would receive the inbound communication and relay it onto the ACS 100. If the end-user 10 selects email or other mode of communication, then an Internet service provider or other provider would encapsulate the message in its standardized format and transfer the message onto the ACS 100.

Referring back to FIG. 2B, at the ACS 100, a protocol translation/mapping gateway 115 receives the various incoming messages and/or media from the various communication devices 200 employed by the end-user 10. The protocol translation/mapping gateway 115 interconnects the various communication networks having different network protocol technologies with the communication protocol employed by the ACS 100 by performing various protocol conversions as it is received by the ACS 100.

In use, the ACS 100 interacts with a guest mobile device 220 or other communication device 200. As with the guest mobile device 220, the guest mobile device 220 can communicate wirelessly through an electronic communication platform, such as by SMS via an SMSC, the Internet or some other messaging communication platform according to this subject disclosure. Although the Internet is shown, various messaging protocols can be used to communicate the various bits of information to and from the ACS 100.

The guest mobile device 220 can communicate an SMS through the packet network 210 to the GSM modem 121 attached to the ACS 100. The GSM modem 121 accepts a SIM card 122 to operate over a mobile network operator. The GSM modem 121 connected to the ACS 100 allows the guest mobile device 220 to use the GSM modem to communicate over a mobile network.

The ACS 100 can communicate an outgoing SMS in a variety of different ways. Since many cell phone carriers allocate e-mail addresses to their customers' phone numbers to enable them receive e-mail text messages, the ACS 100 can transmit an SMS using the allocated email address. The ACS 100 can communicate an SMS through the GSM modem 121 and use AT commands to instruct the modem 121 to send the SMS to the SMSC in the packet network 210 and back to the mobile device 220. Alternatively, the ACS 100 can be connected to the SMSC or SMS gateway of a wireless carrier or SMS service provider and then SMS messages can be sent using a protocol/interface supported by the SMSC or SMS gateway.

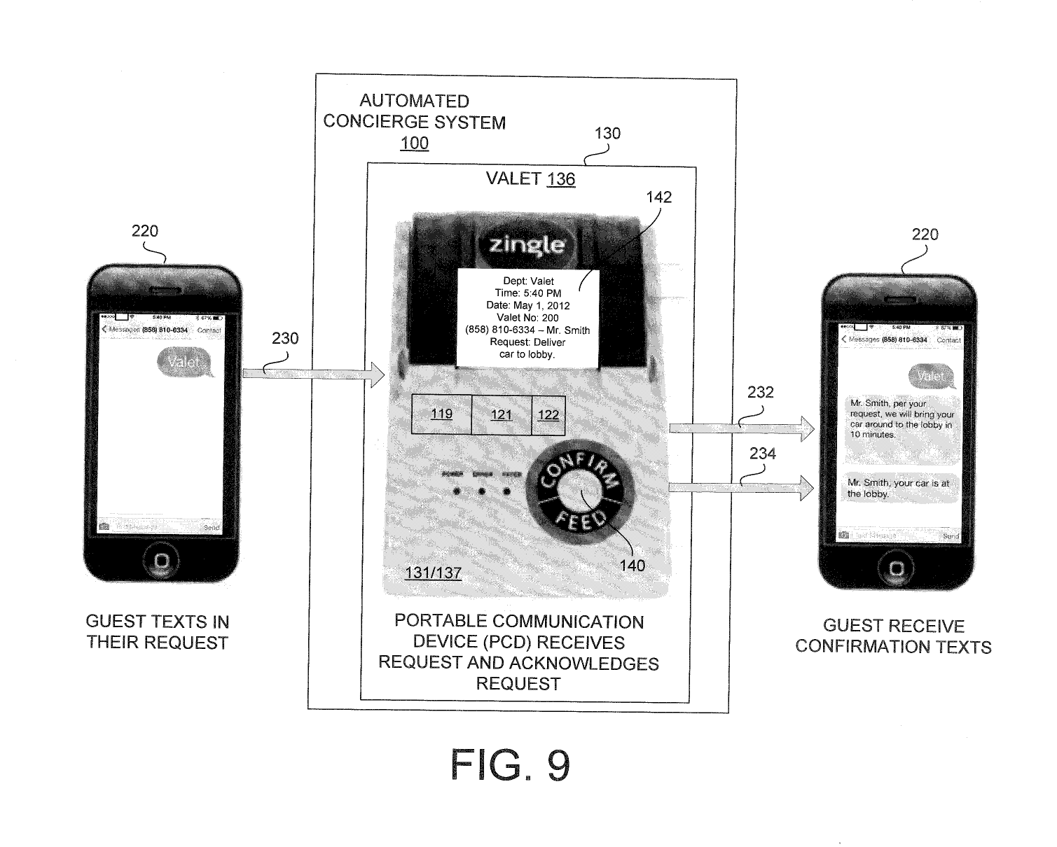

Various modems 121 can be included in different network components at the merchant computer system 50 or the ACS 100. For example, modems 121 can be included in computers 175 or portable communication devices (PCD) 131 (as shown in FIGS. 2A and 9) and the ACS. In this way, the various GSM modems 121 can be used for sending and receiving SMS and MMS messages between each other. The GSM modem 121 can be a dedicated modem device with a serial, USB or Bluetooth connection. The GSM modem 121 is used as a generic term to refer to any modem that supports one or more of the protocols in the GSM evolutionary family, including, but not limited to, the 2.5G technologies GPRS and EDGE, as well as the 3G technologies WCDMA, UMTS, HSDPA and HSUPA. The GSM modem exposes an interface that allows applications such as SMS to send and receive messages over the modem interface.

It should also be appreciated that the ACS 100 is preferably dynamically implemented on a general-purpose computer. However, hotel computing system 102 can also be implemented on a special purpose computer, a programmed microprocessor(s) or microcontroller and peripheral integrated circuit elements, an ASIC or other integrated circuit, digital signal processor, hardwired electronic or logic circuit such as discrete element circuit, programmable logic device such as PLD, PLA, FPGA or PAL, or the like. In general, any device capable of aggregating, coordinating, scheduling, completing and communicating information about the customer requests to be completed by the merchant business in accordance with the subject disclosure may be incorporated.

The various components in the ACS 100 may be interconnected by one or more bidirectional data/control buses or application programming interfaces. Additionally, the ACS 100 may be connected over a wireless communication link to the various other components. It should be understood that circuits or routines performed by the ACS 100 system and method described herein could be implemented as portions of suitably programmed general-purpose computer. Alternatively, each of the circuits or routines could be implemented as physically distinct hardware circuits within an ASIC, or using FPGA, PDL, PLA or PAL, digital signal processor, or using discreet logic elements or discrete circuit elements. The particular form of each of the circuits or routines will take is a design choice.

ACS 100 may be implemented using any known or later developed device or system for connecting one or more of the input/output devices and the computer, including direct cable connection, connection over wide area network, local network or storage area network, connection over an intranet, or connection over any other distributed processing network or electronic communication system.

The memory 111 can also store one or more computer readable control routines used by the controller to operate ACS 100. The memory 111 can be implemented using any appropriate combination of alterable, volatile or non-volatile memory or non-alterable, or fixed, memory. The alterable memory, whether volatile or non-volatile, can be implemented using any one or more of static or dynamic RAM, floppy disk and disk drive, writable or re-writable optical disk and disk drive, hard drive, flash memory or the like. Similarly, the non-alterable or fixed memory can be implemented using any one or more of ROM, PROM, EPROM, EEPROM, an optical ROM disk, such as CD-ROM or DVD-ROM disk, and disk drive or the like.

Furthermore, the subject disclosure may be implemented as a system or method using standard programming and/or engineering techniques to produce software, firmware, hardware, or any combination thereof to control a computer to implement the disclosed subject matter. The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

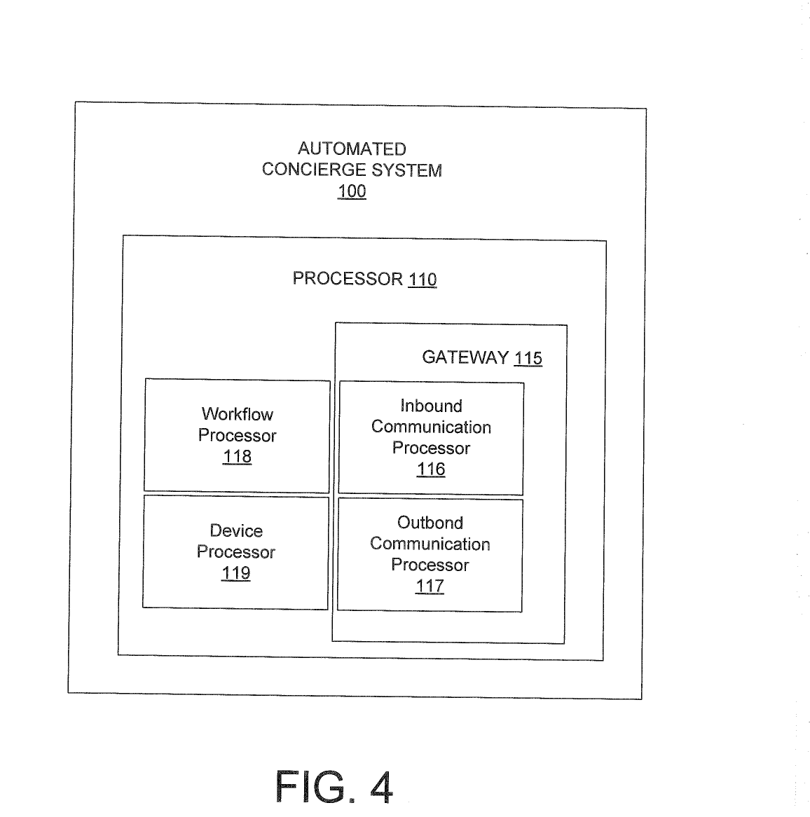

FIG. 4 shows the various programmable microprocessor(s) 110 of the ACS 100 can also be implemented on one or more integrated or disparate processors, such as in the hotel computing system 102, the guest communication devices 200, computers 175 or the portable communication device 131. FIG. 4 shows the programmable microprocessor(s) 110 implemented as including at least 4 processors, an inbound communication processor 116, an outbound communication processor 117, a workflow processor 118 and a device processor 119. The various processors 116, 117, 118, 119 serve the various functional routines in the ACS 100.

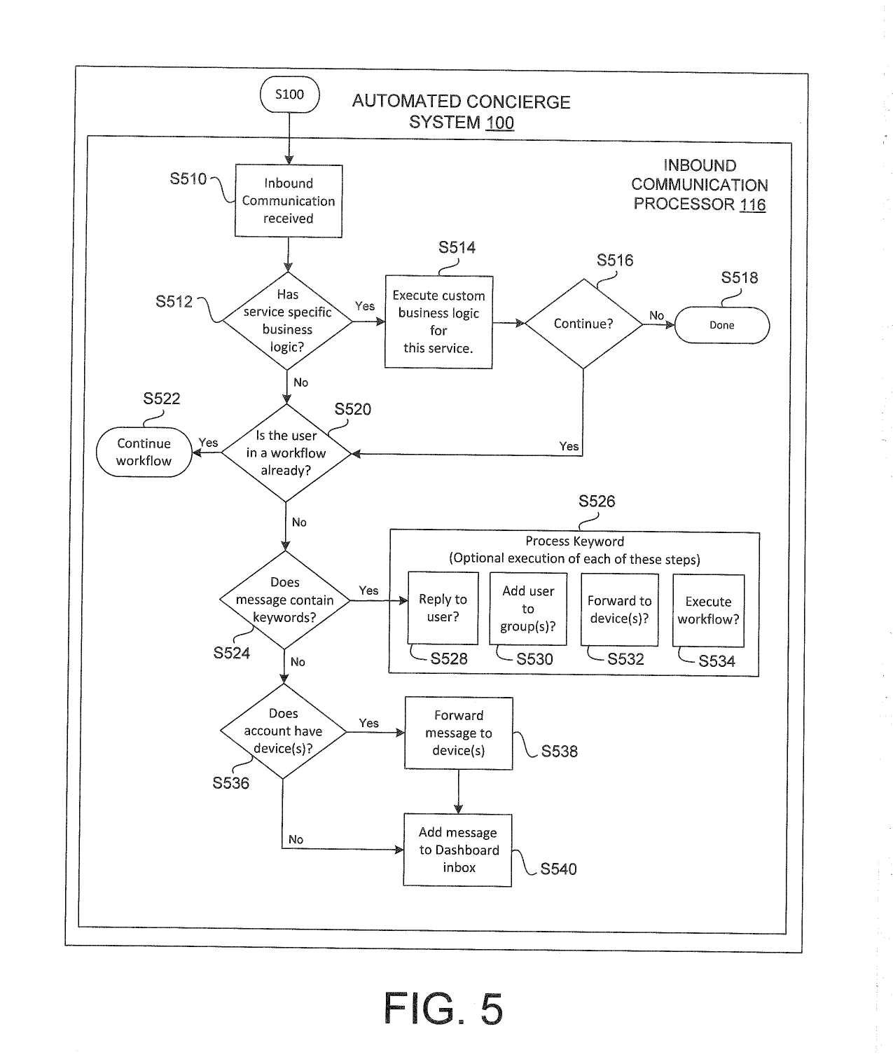

FIG. 5, for example, illustrates an exemplary process embodied by the inbound communication processor 116 of the ACS 100. At step S100, the incoming message 230 has been received and translated by the gateway 115 into a format utilized by the ACS 100, the inbound communication processor 116 may perform the following routing upon receipt of the inbound message or communication.

In step 510, the inbound communication is received by the ACS 100 and sent on to step S512 to determine whether there has been any specific business logic embedded within the inbound communication. Business logic would include customized embedded workflow instructions within the incoming message that the ACS 100 would have to perform. That is, to automate common business tasks, to reduce effort of the merchant staff, and expedite a response to the end user 10.

The business logic comprises a workflow or sequence of connected steps where each step may follow without delay or gap and ends just before the subsequent step may begin. The ordered tasks of routing, transforming or calculating data from one step to the next in the routine. For example, the business logic followed by the routine in registering a new guest is a process (workflow) may comprises various steps described herein. The sequence of events that happen during registration, such as asking for a name, last, then first, the room number, a valet ticket number, length of stay, etc, and then in the last step, the confirmation of enrollment and welcome message would all define the workflow for the particular business logic for registration of a new guest. Automating this process saves the merchant staff time and energy that a workflow routine could accomplish without the need for a staff employee.

In step S512, if there is business logic built into the communication, then the routine will proceed to step S514 where the custom business logic will be executed by the inbound communication processor 116. The routine will next determine if further instructions are necessary by the business logic. If not, the routine proceeds to step S518 and the routine is completed. If, however, in step S516 the routine has further instructions to continue, the routine will proceed to step S520.

In step S520, the routine will determine whether the associated guest user already has an incoming request already in a workflow. The associate guest user may be identified by their phone number registered to their guest mobile device, an IP address associated with the guest mobile device or any other indicia embedded within the incoming message.

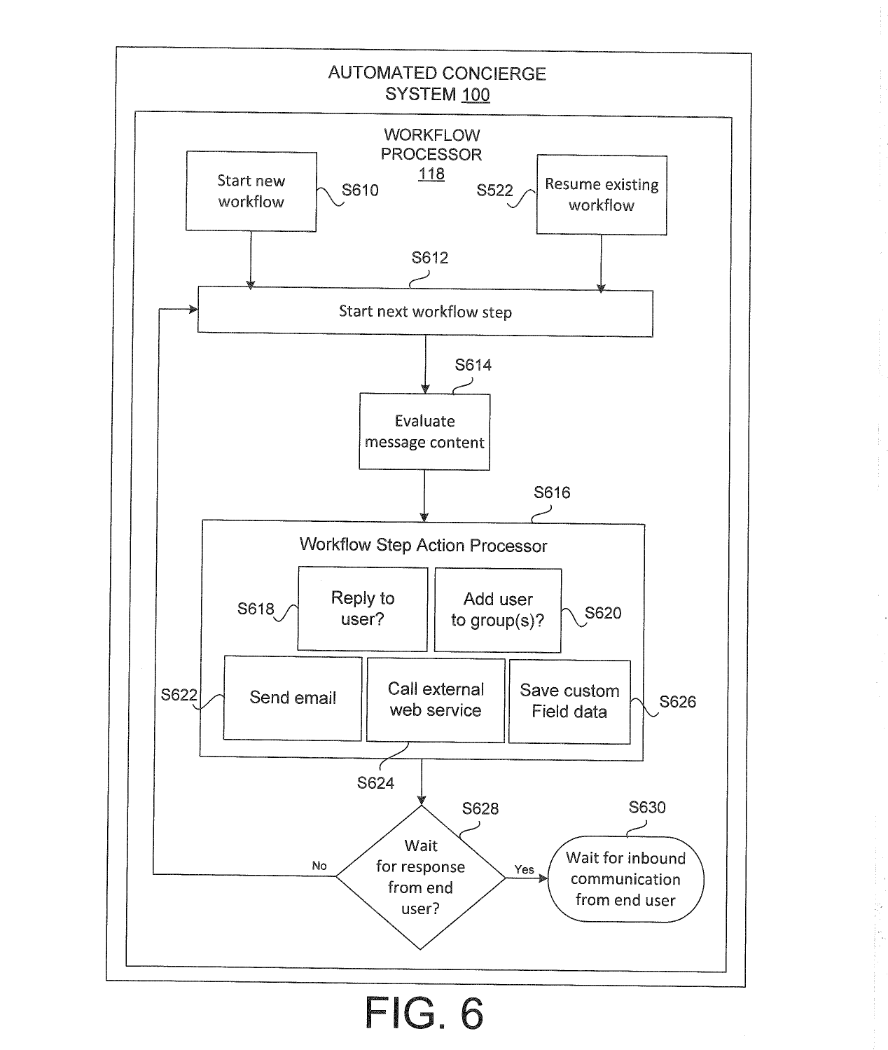

At step S520, if the guest user is already in a workflow, the routine will proceed to step S522 to continue to carry out the instructions provided by the remainder of the workflow (as processed by the workflow processor 118 and described in FIG. 6). If however, at step S520, the guest user is not in a workflow, the routine will proceed to step S524 in which the ACS 100 will determine if the incoming message contains a keyword.

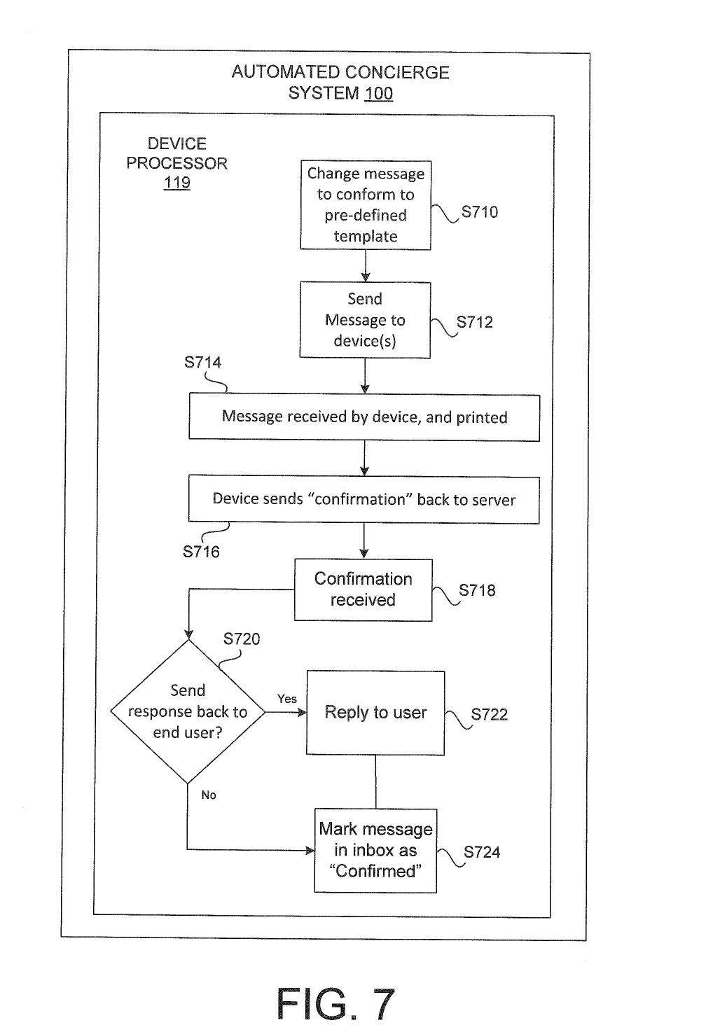

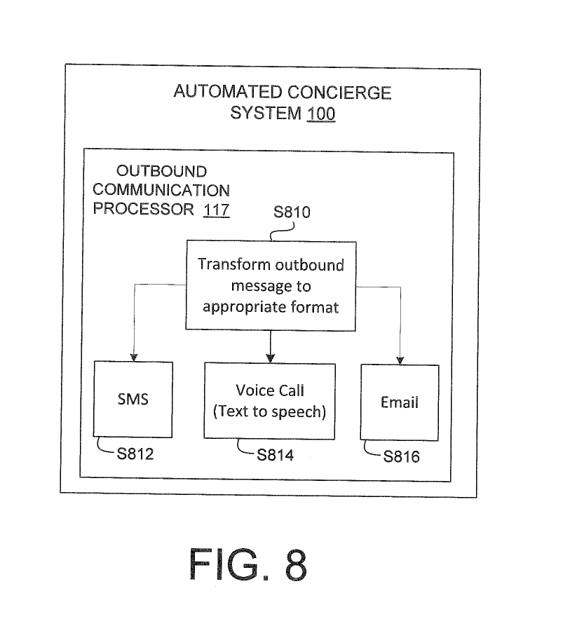

If, in step S524, the incoming message contains a keyword, the routine will proceed to step S526 in which the routine will process the instructions associated with the keyword. One example instruction may include replying to the guest (S528) user mobile device incoming message (as processed by the outbound communication processor 117 and described in FIG. 8). Another instruction might require adding a guest user to a group(s) (S530) where an instruction to associate the guest mobile device with a specific group is requested. Third, the keyword may include a set of instructions to forward the incoming message (S532) to one or more devices (as processed by the computers 175 or portable communication device processor 119 and described in FIG. 7). Alternatively, the incoming message may require in step S534 the further execution of a workflow (as processed by the workflow processor 118 and described in FIG. 6). It is to be understood that various other workflow instructions may be required in response to receiving a keyword embedded within the incoming message.

Likewise, it should also be noted that the reply to user message (S528, S618) may be subject to a scheduled response based on time. For example, if an incoming message 230 came in with the keyword” “Happy Hour”, the particular workflow response may be different based on time of day, and day of week. Late afternoon may cause a workflow response reply message back to the guest mobile device 220 for an advertisement for a promotion at the restaurant bar in the hotel.

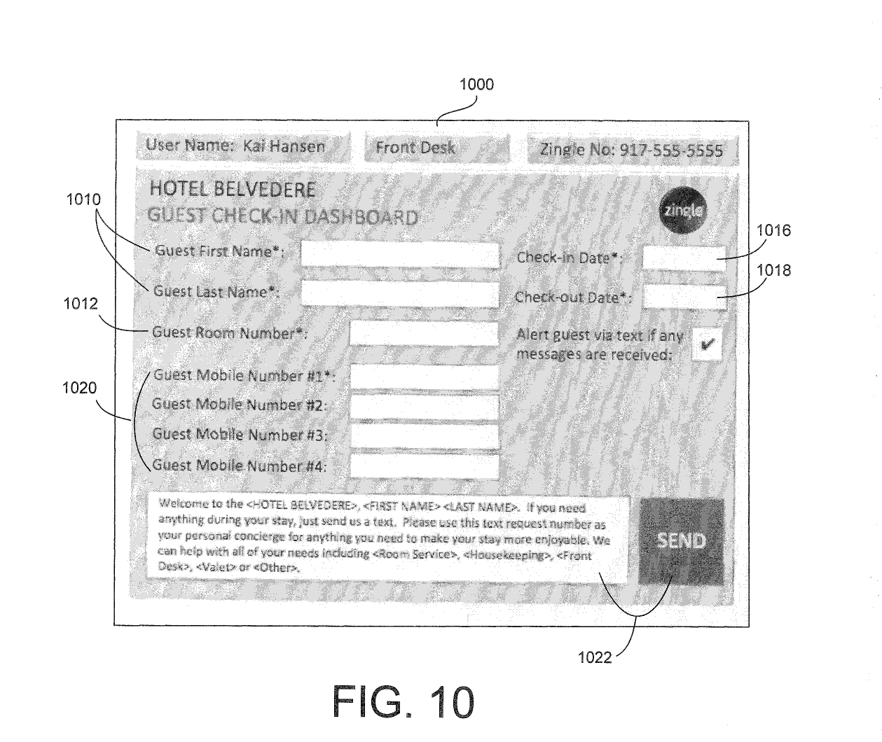

If, in step S524 no keyword is contained within the incoming message, the routine may proceed to step S536 in which the routine determines if the registered guest mobile device has one or more accounts (such as more then one communication device 200) associated with that account. If yes, then in step S538 the incoming message may be forwarded to the other associated devices (as processed by the device processor 118). The incoming message is then added to a dashboard inbox (and shown in FIG. 10) as in step S540. If however in step S536, the routine determines that there are no other communication devices associated with the account, then the routine proceeds to step S540.

FIG. 6 shows an exemplary routine carried out by the workflow processor 118 of the ACS 100. As mentioned previously at steps S522 or S526, if a workflow is resumed/continued, the routine continues at step S522 and then proceeds to step S612 shown in FIG. 6 of the workflow processor 118.

If however, a new workflow is started, the routine begins at step S610 and then proceeds to step S612. At step S612, the routine processes the following workflow routine step and then proceeds onto step S614. In step S614, the message content is evaluated to determine what type of workflow processing step is required by the workflow processor S616.

In step S616, the workflow processor 118 may decide that a reply to the guest mobile device (S618) would be necessary (as performed by the outbound communication processor 117). Secondly, the workflow processor 118 may process the routine for adding the user or guest user device (S620) to one or more groups. Alternatively, the workflow processor 118 may interact to generate and send an email (S622). The workflow processor 118 may alternatively call or connect communication to an external web service (S624). The workflow processor 118 may however cause the routine to save custom field date (S626) to the ACS 100. It should be understood that various additional workflow steps may be performed by the workflow processor 118 at this stage in the routine. Once one of these actions has been performed, the routine proceeds to step S628.

In step S628, the workflow processor 118 may be tasked to determine whether it should wait for a response from the end user guest mobile device. If not, then the routine proceeds back to step S612. If yes, then the routine proceeds to step S630 and waits for the inbound communication from the end user guest mobile device for a predetermined period of time.

FIG. 7 depicts an exemplary routine carried out by a device processor 119 in the ACS 100. As shown in FIGS. 2A and 9, computers 175 or a 131 portable communication device 131 may be suitably located in each of the various service departments 130. For simplicity sake, the computers 175 or portable communication devices 131 may be interchanged in this description. The device processor 119 can instruct incoming message 230 from a guest to route to the computer 175 or portable communication device 131 located in a particular service department 130 who can then interact with the incoming request from the guest, such as to provide acknowledgement, status, timing or other task completion information. As mentioned previously at steps S526 or S538, if a message is forwarded to a portable communication device 131, the device processor 119 routine proceeds to step S710.

In step S710, the incoming message may be converted to conform to a pre-defined template understood by the portable communication device 131. The incoming message may be sent through the ACS 100 or communicated directly to the portable communication device 131 in each of the various service departments 130, and the incoming message copied to the ACS 100. Thereafter, in step S712 the message is sent to the portable communication device 131.

In step S714, the incoming message request is received by the portable communication device 131 and printed on a printer medium 142 embedded within the portable communication device 131 (such as shown in FIG. 9). In an automated state, the incoming message request is automatically printed on the printer medium 142 upon receipt of the incoming message request at the portable communication device 131. In a semi-automatic mode, the incoming message request is printed after a hotel employee acknowledges receipt of the incoming request.

In step S716, the device processor 119 of the portable communication device 131 may send a “confirmation” message back to the ACS 100. Alternatively, the “confirmation” message can be sent back directly to the guest mobile device 220 from the portable communication device 131 with a copy of the confirmation message back to the ACS 100.

In step S718, notification of receipt of the confirmation being received by the ACS 100 from the portable communication device 131. In step S720, the device processor 119 of the portable communication device 131 may also determine if a response should be sent back to the end user guest mobile device 220. If yes in step S720, then a reply message will be sent back to the end user guest mobile device 220. Otherwise, if in step S720, the portable communication device processor 119 determines no, a message is marked in the inbox as “confirmed” receipt by the portable communication device 131.

FIG. 8 shows an exemplary routine carried out by the outbound communication processor 117 of the ACS 100. The outbound communication processor 117 of the ACS 100 may be suitably located in the ACS 100. As mentioned previously at steps S526 or S616, if a message is to be replied back to an end user guest mobile device, the routine proceeds to step S810 in FIG. 8.

In step S810, the outbound communication processor 117 transforms the outbound message within the gateway 115 to an appropriate format to be sent back out to the end user communication device 200. That is, the outbound communication processor 117 may convert the message to an SMS that is communicated back through the GSM modem 121 over a control channel to the end user guest mobile device 220.

Alternatively, the outbound communication processor 117 may decide to transform the outbound message to a voice call communication in which for example, a text to speech conversion is made and sent via the outbound message. Alternatively, the outbound communication processor 117 may convert the outbound message to an email communication format and send back to the communication device 200 in that format, or some other desired format.

Referring back to FIG. 2, the communication network 210 may be any suitable communication network platform for transporting various communications, such as the Internet, a data packet network, a cellular network, or other electronic communications network platform.

The guest device 200 may be selected from a variety of different communication devices, such as a mobile device 220, a computer 222, a PDA, and/or other communication device 224. In this example, the guest device 200 used will be a wireless mobile device 220 that communicates an SMS via a mobile communications carrier 260 and an SMSC over an unused radio control channel to the ACS 100.

The concierge application 120 is built on a software platform that operates on the ACS 100 to allow a hotel merchant (e.g., hotel staff, an automotive repair facility, hospital staff or the like) to quickly and conveniently register hotel guests or customers, manage their various requests and/or inquiries, and fulfill those requests with a plurality of available products or services with minimal interaction required by the hotel guest or other customer.

The ACS 100 may be provided as a semi-automatic or virtual automatic operator/concierge adapted to interact with the concierge application 120 to receive and send acknowledgments and other messages regarding various electronic message information (such as email or text-based data messages) from their hotel guest devices 220. For example, in FIG. 1, a guest/customer 10 may text a request from their mobile device 220 into the virtual concierge application 120 at the ACS 100 for a particular requested action to be completed by the hotel merchant.

When the virtual concierge application 120 is managed semi-automatically to partially include an individual concierge (e.g., someone on the hotel staff) who receives and participates in the workflow process, such as coordinating the various virtual requests and/or inquiries from the hotel customers, the individual concierge can efficiently schedule and assign the requested task for completion to an appropriate service department 130 to have the task completed. Each transaction made at the merchant computer system 50 is logged by the ACS 100 in the database 123 and can be reviewed on an ACS 100 dashboard user interface, as will be described in more detail later.

Alternatively, the automatic virtual concierge application 120 can be an automated program embedded in the ACS 100 that automatically coordinates and schedules the task to be completed based on available resources, such as the current work orders in queue and the number of employees available, the guests schedule, their location on property and the availability of the hotel staff in the particular department and/or others capable of assisting to complete the requested service.

Although shown as a remotely located server, the ACS 100 may reside within the business entity and may not have to rely on the communication network 210 or other network nodes located remotely outside of the business entity.

The various network components in the merchant computer system 50 can be electronically connected and/or wirelessly connected to ACS 100 so that data information from the various network components can be received by the ACS 100. As shown in FIG. 2A, various computers 175 or portable communication devices (PCD) 131 may be individually located within each of the various service departments 130 within the merchant computer system 50 of the merchant's hotel. Commonly owned U.S. application Ser. No. 12/624,211 entitled “System and Method For Transferring Information Between a Remote Computing Device and a Central Business Unit” is directed to describing how a single portable communication devices (PCD) operates, the contents of all of which are hereby incorporated by reference herein in their entirety into this disclosure.

The portable communication device 131 is a small portable electronic messaging device (such as SMS based messaging). The computers 175 or portable communication devices (PCD) 131 can receive the incoming message 230 requests forwarded from the concierge application 120 to each of the various hotel service departments 130. The portable communication device 131 is adapted to receive the various incoming message 230 requests generated from the guest customer mobile device 220, such as for registration, room service, housekeeping, valet and/or other services, products or information. The computers 175 or portable communication devices (PCD) 131 assists in providing an efficient communication exchange for incoming message requests thereby improving the customer service experience by helping to eliminate phone order confusion and hotel guest wait time for various requested services. Although shown in use with the ACS 100 in FIGS. 1-2A, it is to be understood that ACS 100 can be used without the portable communication device 131.

In use, various benefits can be realized by the ACS 100 for the hotel business, as well as numerous other business applications. For example, by maximizing and increasing the efficient use of the hotel staff and resources, increased revenue can be realized through the use of the ACS 100.

According to this subject disclosure, more than one computer 175 or portable communication devices (PCD) 131, 133, 135, 137, 139 may be located in the various service departments 130 on the business premise. The portable communication devices 133, 135, 137, 139 are capable of sending and receiving instructions and replies between the merchant computer system 50 and the concierge application 120 in the ACS 100. Alternatively, the computers 175 or portable communication devices 133, 135, 137, 139 may communicate back and forth directly to and from the guest mobile device 220 making a request for service while copying its communication to the dashboard at the ACS 100.

Referring to FIGS. 2 and 9, as part of the ACS 100, the concierge application 120 is connected to each of the various service departments 130 at the merchant's establishment. Each of the various service departments 130 may have computers 175 or portable communication devices (PCD) 131 interconnected to the concierge application 120. For simplicity sake, the computers 175 or portable communication devices (PCD) 131 may be used interchangeably. The portable communication device (PCD) 131, 137 may be shared or individually located in each of the various service departments 130 to receive the various requests from the concierge application 120.

FIG. 9 shows one exemplary embodiment in which an end user guest mobile device 220 communicates with the ACS 100 a specific incoming message 230 request. In particular, the guest mobile device 220 generates and sends in an SMS message 230 over a control channel with keyword “valet” when the customer is about ready to come on down and retrieve their car from the valet. At the valet office, the attendant employee will receive the request to retrieve that customer's vehicle and have it waiting at the entrance for the customer's arrival.

More specifically, the incoming message 230 request is generated by the end user 10 on their mobile device 220. The inbound communication or message 230 (step S510) is received by ACS 100. The inbound message 230 includes the keyword “valet” (step S524). As mentioned in FIG. 5, the inbound communication processor 116 performs various workflow actions (step S526) in response to receipt of the incoming message 230 requests.

As shown, the incoming message 230 request may be forwarded from the ACS 100 to the portable communication device 137 located at the valet service department 136. The inbound communication processor 116 then awaits a response from the valet service department 136 confirming receipt of the incoming message 230 request. The confirmation may be made by personnel in the valet service department by actuating an actuator 140 on the portable communication device 137 (or computer 175). Simultaneously, a workflow (step S610) to retrieve the vehicle is started.

In response to actuation of the button actuator 140 on the portable communication device 137 in the valet service department 130, the portable communication device 131, 137 sends back a confirmation message (step S528, S618) confirming receipt of the incoming message 230 request generated by the guest mobile device 220 to retrieve their car.

The confirmation return message 232 from ACS 100 back to guest device 220 is sent automatically upon receipt of the incoming message 230 by the ACS 100, or by manual acknowledgement of receipt by an employee staff member who manually acknowledging receipt of the incoming message 230 or by the staff employee by actuating the button actuator 140 on the portable communication device 131, 137.

Likewise, once the requested task is completed, the concierge application 120 and/or portable communication device 131, 137 can send back a completion return message 234 indicated by one of the various merchant employees in each of the respective departments of the completed task. For example, in FIG. 9 the subsequent reply message 234 back to the guest mobile device indicates that the car is now at the lobby. These various messages are also recorded and added in real time to the dashboard inbox on the ACS 100.

More individuals are increasingly becoming familiar with emailing, texting and using various text-based communication devices as a common communication practice. As such, customers will be inclined to use text-based communications to make various requests of the ACS 100. Another prime advantage to using ACS 100 in a hotel environment is that the hotel customer will no longer have to wait in line to make a request from a hotel staff person. Thus, the inconvenience of waiting in a line, or being placed on hold in a queue during a call awaiting a hotel staff person to pick up, can be eliminated. As a result, the hotel customers' overall experience will be pleasant and likely to promote word of mouth referral and repeat patronage.

The ACS 100 will also help to eliminate mistakes in the requested communication for service as both the customer and the ACS 100 will have a printed record of the specific request to abide by when fulfilling the requested task. That is, the various requests can be printed out by the printer 57 at the merchant computer system 50 or the computer 175 or portable communication device 131 (as shown printed by a printer 142 in FIG. 3) in each of the various departments so the hotel guest and hotel merchant service provider can clearly understand the customer request. Likewise, the various requested orders can be easily tracked and reviewed by the ACS 100, hotel personnel or the guest at any time for accountability. A periodic accounting of requested orders can be provided by the ACS 100. Various reports may be generated to assist maintaining an accounting of the messaging and accountability by the merchant in its responses to the incoming requests. In use with the ACS 100, the portable communication devices 131 are easy to install in the various service departments 130 and available to deploy in any location within the ACS 100. Various surveys may be created by the ACS 100 from the data stored in the database 123.

The advantage to using ACS 100 in an electronic communication messaging environment is that interaction via electronic messaging is immediate and in particular with SMS uses very little network resource. The message can be printed as soon as it is received as a verifiable record and there is no unnecessary delay as a result of inadequate staffing being unavailable to take a request, such as at a busy registration counter when a guest first arrives at a hotel and has many guests in line ahead of him or her.

In use, the guest mobile device 220 does not require any additional software or third party application embedded within their mobile device to communicate with the ACS 100. Although unnecessary, the ACS 100 may have a client application that can be downloaded onto a guest device 200 to enhance the communication between the ACS 100 and the customer's device. Use with the ACS 100 is simple and not resource intensive as it may use SMS that are transmitted over an unused control channel. Bidirectional communication with ACS 100 is low and as simple as composing and sending a text message, and receiving and replying to various electronic messages from the ACS 100 to the customer's mobile device 220. Although shown as a cloud based system, the ACS 100 can be configured as a standalone system operating on a local access network (such as WiMax, Bluetooth or other independent network) or can be tethered and networked into the Internet or some other communications network solution.

The portable communication device 131 can be connected to a tethered power source, or can be powered by batteries received in the device. A print medium, such as thermal paper (142, as shown in FIG. 9) or other print medium (for computers 175) may be used to print the requests from the guest mobile device 220 (and/or forwarded from the ACS 100) at the service departments 130. In the reply messages to the guest mobile device 220, various other types of data and/or links may be included for the benefit of the hotel guest, such as instructions, list of keywords, menus, guides and/or other promotional material may be contained as part of the reply message.

Various dedicated identifiers, such as text-in numbers may be distributed to the hotel guest customers. When a request is received at the ACS 100 and communicated to a portable communication device 131 in the various service departments 130, the portable communication device 131 may notify an employee in that service department 130 with an audio alert via a speaker and/or the printed receipt 142 of the incoming message 230 from the hotel guest. A reply confirmation message 232 may be sent back from the ACS 100 to the guest mobile device 220 with a detailed copy of their requested order or service, a pick-up, delivery or completion time and any other customized message to the guest mobile device 220.

Use of ACS 100 appears seamless to the customer as it requires no change to the customer's accustomed communication preferences. The information transmitted between the hotel customer and ACS 100 is securely encrypted by the security 112 module and may be securely associated to a particular customer by their guest credentials or ID, such as by their cell phone number and/or other specific information tied to their profile.

FIG. 10 shows an exemplary dashboard user interface 1000 in ACS 100 for receiving customer information by the hotel guest concierge front desk personnel to enroll the guest into the ACS 100. As shown, various types of information about a guest are collected in this screen that identifies aspects of the hotel guest's profile. Various other bits of data information can be provided in the dashboard for, or about the customer, the hotel, its services, products and other hotel related information. The displayed data can be automatically updated by ACS 100. The frequency of the update may vary by merchant and their preferences.

Once the hotel customer initiates a registration request either in person or via an automatic registration option, the following information shown in FIG. 10 may be collected by being input by the guest and/or provided to the hotel concierge by the guest. That is, the guest's name 1010, their room number 1012, their check-in 1016 and check-out 1018 dates. Furthermore, additional guest mobile numbers 1020 can be added to the guests' profile, such as for a spouse and children or if the guest has two or more messaging devices. Other customizable information about the guest can be included such as their assigned valet ticket number and/or other special needs.

The guest information can be provided to the ACS 100 in a variety of different ways. For example, a front desk concierge can receive and enter the information directly from the guest, or the guest can access the ACS 100 system at the hotel website and fill in the information from the guests' communication device 200. Alternatively, the guest can use their mobile device 220 to interact with the ACS 100 via electronic message(s) to provide the information in FIG. 10. Other electronic modes for sending and receiving this information to the hotel establishment according to this subject disclosure are also possible.

Once ACS 100 receives the registration information, the virtual concierge application 120 in the ACS 100 can generate and send (1022) back a received acknowledgement and welcome message (e.g., an SMS) from the hotel merchant to the hotel guest as shown in the lower box in FIG. 10. In the message, an identification number (such as the phone number 917-555-5555) can be associated with the guest and provided for use with ACS 100 during their stay to tend to the hotel guest needs. Alternatively, the number could be a short code and/or any other identification code capable of receiving SMS messages, or the like.

By sending the hotel guest a welcome text to their mobile device 220, and enrolling them in the ACS 100, communication going forward is simplified between the guest 10 and the hotel merchant. That is because text messaging is a simple mode of communication that does not overly tie up hotel personnel, such as a face to face communication or by a phone conversation. The message is short, convenient to compose and send and requires little time to complete. Communications sent back and forth are succinct and clear as to their intent in their written form. By using SMS, other external applications, external downloads, phone number look ups and/or little other information is not necessary by the guest. ACS 100 provides an all inclusive interactive method and system capable of handling various requests from the hotel guest.

By registering the hotel customer, any and all electronic communication that is sent to and from the hotel merchant can be used by ACS 100 to automatically assign the room and guest profile information to ACS 100 software communication platform so the hotel merchant knows the identification of who the electronic message is from, and that the message has been authenticated with registration information stored in the ACS.

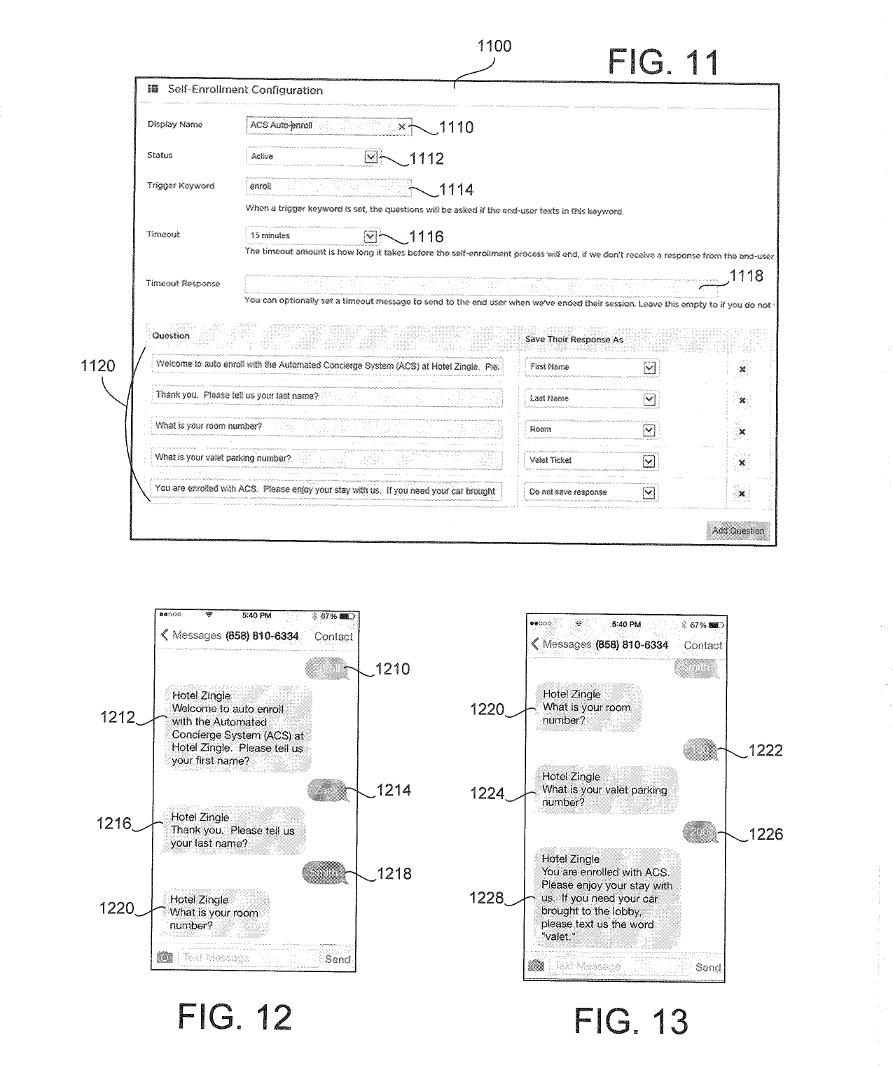

FIGS. 11-13 illustrate an exemplary method for automatically enrolling in the ACS 100 from a guest mobile device 220. FIG. 11 depicts a “Self-Enrollment Configuration” dashboard page 1100 on the ACS 100. At location 1110, a display name for the dashboard can be input or selected. The “Self-Enrollment Configuration” can be set to active or inactive 1112 and a preferred timeout 1116 can be set. A “trigger keyword” 1114, phrase or other indicia, such as “enroll” can be text in from the guest mobile device 220 to initiate the “Self-Enrollment Configuration” process. Optionally, a timeout message can be inserted into a “timeout response” field 1118 that can be sent to the end user when their session has ended.

In use, when the “Self-Enrollment Configuration” dashboard page 1100 is activated by receipt of the trigger keyword (e.g., “enroll”), a workflow can be initiated to generate a series of questions 1120 that can be sent to the guest mobile device 220 requesting self-enrollment in ACS 100. The questions 1120 can be sent in a variety of different ways such as individually, seeking an individual and successive response from the guest to each of the questions; or as a group of inquiries, seeking a number of associated responses to each of the questions. In this latter scenario, the ACS 100 can parse out the various answer response with each of the associated questions asked, and stored an appropriate response in each of the inquiry fields in the ACS.

Example shown in FIGS. 12 and 13 is seen from a perspective of a display on the guest mobile device 220. A first keyword is sent as an incoming message 230 into the ACS 100 from a guest mobile device 220. The ACS 100 receives the inbound communication message 230 (step S510), interrogates the message and determines that a keyword (“enroll”) exists in the message (step S524). The ACS 100 recognizes a specific workflow request for automatic Self-Enrolment associated with the keyword “enroll” and proceeds to the automatic routine question workflow 1120.

The ACS first automatically replies (1212) with a welcome message and a request for a first name, and waits a predetermined period of time for a reply. When the guest mobile device 220 returns replies with first name (1214), the ACS 100 automatically stores the information and generates the next question.

The ACS 100 then automatically asks for a last name (1216), and waits a predetermined period of time for a reply. When the guest mobile device 220 replies with their last name (1218), the ACS 100 automatically stores the information and generates the next question.

The ACS 100 then automatically asks for a room number (1220), and waits a predetermined period of time for a reply. When the guest mobile device 220 replies with a room number (1222), the ACS 100 automatically stores the information and generates the next question.

The ACS 100 then asks for a valet parking number (1224) to which the guest mobile device 220 replies with their valet number (1226). When the guest mobile device 220 replies with the valet parking number (1226), the ACS 100 automatically stores the information and generates the next response.

The ACS 100 then sends back a return message (1228) with a successful enrollment message with additional information about how to use ACS messaging.

The workflow 1120 in the “Self-Enrollment Configuration” is one example of many automatic provisioning routines that can be programmed in the concierge application 120 of the ACS 100 and triggered by receipt of a specified keyword in an incoming message 230 from a guest mobile device 220. One of ordinary skill in the art would understand that various other questions may be provisioned for a variety of different applications.

By way of another example, the request from a guest for their vehicle to be returned to the front lobby may be embedded as a programmed routine or workflow in which the various steps for obtaining the vehicle are interactively completed by the hotel valet and the guest in real time. In a first step, the car is requested with an incoming message containing keyword “valet.” In a second step, the message is confirmed with an estimated time of arrival reply message. In a third step, the valet brings the car to the front lobby and a notification is sent to the guest that their car is available for pickup. In a forth step, the guest confirms receipt of the vehicle and a tip amount to apply to the valet. In a fifth step, the tip amount is set up for debit from the guests' account associated with their hotel account profile. In a sixth step, the guest confirms the debit to be processed. In a seventh step, the valet gets notification of a tip allocated from the guest. In an eighth step, the valet and/or hotel concierge confirms receipt of the tip and provides a thank you message back to the guest.

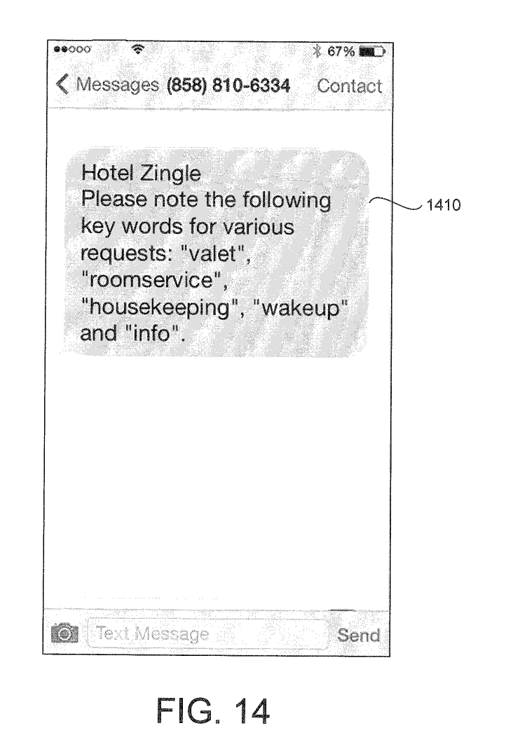

FIG. 14 depicts a follow up reply message 1410 from the concierge 120 upon successful enrollment with helpful information and a legend directed to the various keywords and services that they provide. In the reply message 1410 from the ACS 100, various keywords can be embedded into the message as selectable commands from which a new request can be made from an end-user 10 on their guest mobile device 220 to the ACS 100.

According to this exemplary routine, a guest can automatically enroll in an expedient manner without further interaction with a human hotel concierge and can take advantage of the convenience and efficiency of the ACS 100.

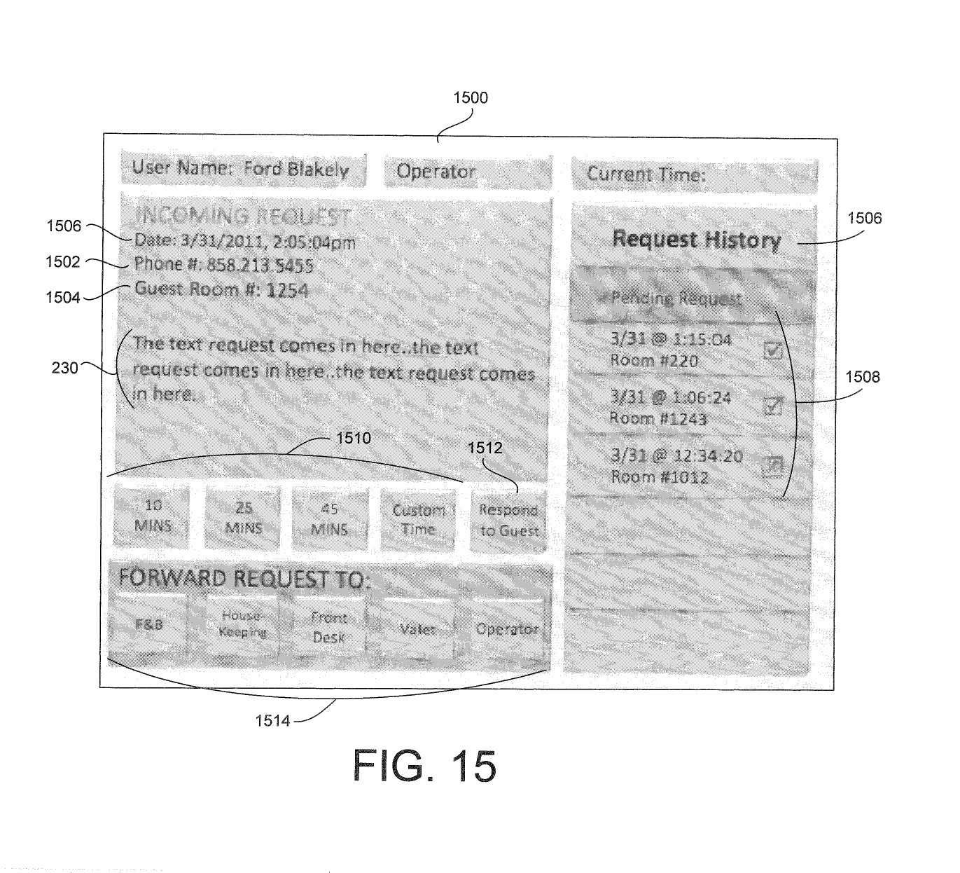

FIG. 15 illustrates an incoming request dashboard view 1500 of an incoming message 230 request. As shown, a phone number 1502 of the guest mobile device 220 can be used as the identifier that associates the guest with various other information, such as the guest room number 1504.

The incoming message 230 request may include date and time stamped information 1506 so that hotel merchant can track its response time and ensure a rapid response to the incoming request. On the incoming request dashboard 1500, request history information 1506 showing other pending requests 1508 can also be provided so that a proposed completion time 1510 for the instant request can be scheduled in a timely manner understanding what other pending requests are currently in the queue. The concierge can set up a quick response message 232 back to the guest mobile device 220 by selecting the button 1512. The concierge can also send the incoming message 230 to one of the service departments 130 capable of fulfilling the request by selecting the appropriate service department button 1514.

ACS 100 provides an electronic solution for the hotel guest to exchange communications with the merchant's hotel staff via the ACS 100 during the course of their stay. The hotel guest can communicate via their mobile device 220 with the ACS 100 for all types of needs (i.e., for example, room service needs (e.g., food), housekeeping needs (e.g., more towels), valet or taxi car request, luggage, food & beverage needs, special celebration arrangements when away from room, and/or various other miscellaneous requests.

In more detail, the ACS 100 platform receives an incoming message 230 request from a guest mobile device 220. In the request, various types of information can be extracted and provided to the virtual concierge 120, such as the length of stay, their guest priority level, the room number 1504 the request is coming from, other requests that may have come from that customer, etc. In response to the incoming request, the virtual concierge application 120 can assign a completion time frame 1510 for fulfilling the request, such as 10, 25 or 45 minutes to fulfill the task. Likewise, the virtual concierge application 120 can create a customized time frame. Likewise, the concierge application 120 can respond to the guest immediately via button 1512. The time from the receipt of the message can be regulated by the concierge 120 of the ACS 100 in order to coordinate staff resources in the most efficient manner.

The virtual concierge 120 can forward the request to one of the merchants service departments 130 for fulfillment (such as F&B, Housekeeping, and Front Desk, Valet, Operator or the like) by pressing one of the buttons 1514 on the ACS dashboard user interface 1500. The scheduled time for completion and coordination can be performed manually by a hotel manager overseeing the ACS 100. Alternatively, the ACS 100 can schedule and coordinate completion of the incoming message 230 request in an automated fashion. The ACS 100 can determine scheduling based on an understanding of hotel employee resources at that particular time the request is to be performed and schedule the required staff's time to complete the task to maximize the efficiency of the hotel staffing.

The ACS 100 system can also provide a detailed list of the various other pending requests, their status, such as completed or pending. A rating can be associated with the pending request task list 1508 that would indicate what level of priority that customers' requests should be given by the hotel to handle their request in a timely manner. The incoming request can be modified by either the hotel guest, the concierge application 120 or a hotel merchant employee.

Although not shown in FIG. 10, payment information about the hotel guest 10 can be included on the dashboard view 1500 in ACS 100 (as shown in FIG. 2) to automatically charge the guest 10 for their particular request. As described in more detail later, the concierge application 120 can also add additional customer names and cell phone numbers (or other identification for the communication devices 200) to the room account (such as a spouse cell number, kids, etc) for added use and authentication.

When an incoming message 230 is received from a guest by the ACS 100, the incoming message 230 from the guest activates an audible or other conspicuous alert output through to an output device 58 in the merchant central server 53. Likewise, the incoming request can be simultaneously sent to an assigned service department 130 and a conspicuous alert can be made at that service department 130 by the computer 175 or the portable communication device 131 as well. The audible, tactile or visual notification of the incoming message 230 request can ring or alert for a predetermined period of time until the message request is acknowledged and time stamped as received by ACS 100, or other hotel staff person receiving the message (such as for example, Jane Smith, Front Desk Manager #2; or John Doe, Operator #3; or Mary Jane, Room Service #4; or Jane Doe, House Keeping #5; or Betty White, Valet #6).

The active time, date and name stamp permits the concierge application 120 and merchant hotel management to review completion of incoming guests requests. This information is particularly helpful to ensure that permissible follow-up time frames are fulfilled (and by which particular merchant employee). The dialogue between the hotel guest and hotel merchant via ACS 100 can also be reviewed to ensure compliance with the merchant hotel guidelines and protocol.

Recording the written conversation allows more effective control by the merchant to ensure that their communication guidelines and timeliness of response are consistent and being adhered to by their staff when communicating with guests. If for any reason, a merchant employee does not respond to, or fulfill a guest customer request in a timely manner, the ACS 100 software platform can send an alert to the assigned employee responsible for managing fulfillment of the request, such as via email or electronic communication to an on-duty management mobile device or other communication device to notify and escalate the guest's unanswered request.

The ACS 100 system of identifying specific guests by a mobile device number (or other identifying information in their profile) and their specific incoming requests to be completed over a specific period of time has a variety of uses outside of the hotel hospitality business. The ACS 100 would have similar widespread usage and advantages in various other customer focused business segments. That is, in a business frame work where there is a known customer base (or quickly identifiable) and an identifier (such as a mobile device tied to a cell phone number) which can be collected and stored by the ACS 100. Various business segments ideally for use with ACS 100 include, but are not limited to; auto dealerships for service coordinating, hospital staff-to-patients, hair salons, dry cleaners, and the like.

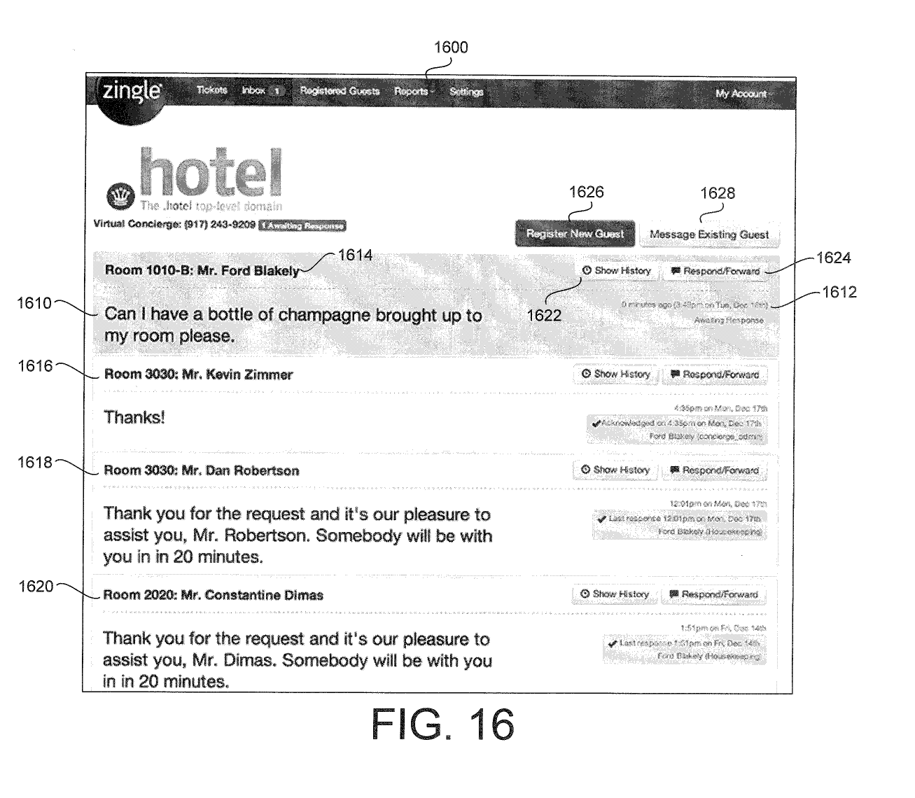

FIG. 16 illustrates a dashboard view 1600 of various pending requests. The top line incoming message 1610 depicts an example of a hotel guest (Mr. Ford Blakely) requesting a bottle of champagne to be brought to his room. In this example, the request arrives at the ACS 100 with pertinent information about when (1612) the request was made, what room and virtual identification (1614) and other pertinent profile information about the guest. The ACS 100 dashboard view 1600 shown herein also shows other requests (1616-1620) from other hotel guests with their associated room and request information, as well as the current status of their requests. The most recent request(s) (1610) may be highlighted to differentiate it from others previously reviewed until acted on or acknowledged by the ACS 100. An audible or other alert signal can be activated once the request is received by the ACS 100, and continues until the virtual concierge 100 or other hotel employee acknowledges the incoming message request. A history button (1622) surrounding communications from a particular guest can be populated and reviewed. A respond/forward button (1624) can also be provided to respond to a particular guest and/or to send the incoming request on to a specific service department 130 to attend to the specific request. Since SMS is a store and forward message communication, check marks can be embedded in the ACS 100 to confirm that a particular message has been successfully delivered to a guest along with a time and date stamp (1612). Other virtual buttons 1626, 1628 can be embedded into the dashboard interface 1600 to complete other tasks, such as to register a new guest or to message an existing guest.

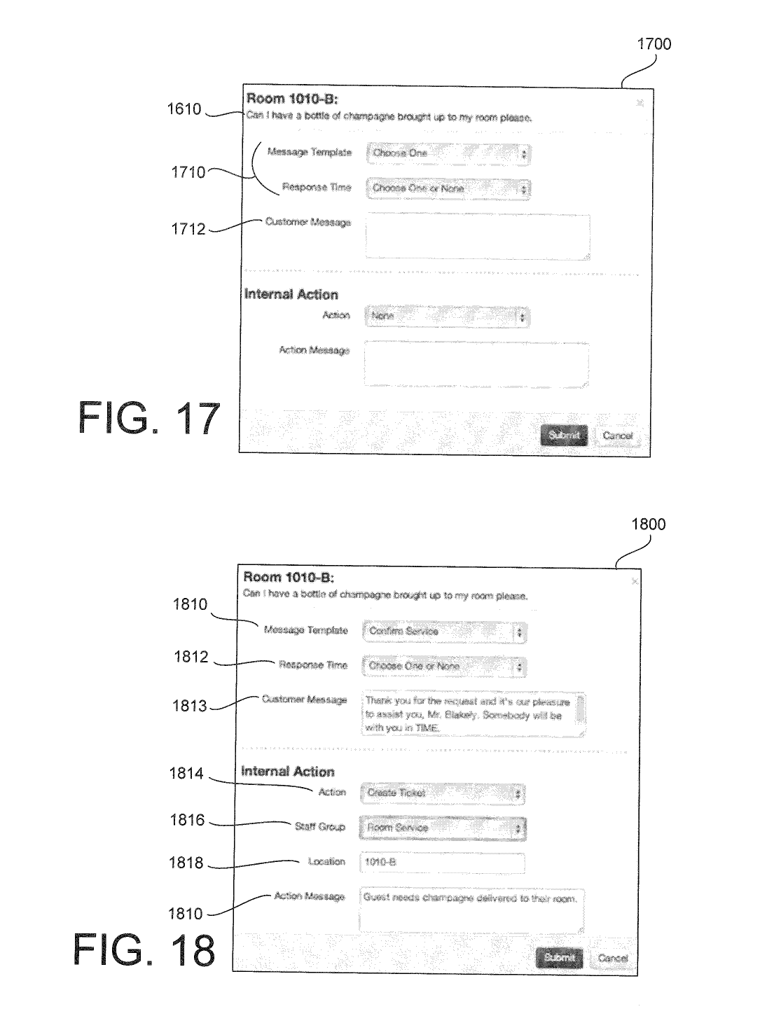

FIGS. 17-18 show dashboard views 1600, 1700 of a response message template in the ACS 100 interface. A hotel operator can quickly and efficiently create a reply message 232 in response to the incoming message 230 request by selecting various drop down menus 1710 in the reply message template 1700 and/or typing in a personalized response 1712 informing the customer of receipt of his message and acknowledgement that someone would fulfill their request soon.

At the same time, the concierge application 120 in the ACS 100 can forward or send an internal action item to one of its internal service departments 130 to handle the specific incoming message 1610 request. As shown in FIG. 18, the various drop-down menus were selected (1810-1812) and a personalized message (1813) was filled in to fulfill the incoming message 1610 request. Likewise, an internal action ticket (1814) was created for a staff group (1816) or service department 130 (i.e., a ticket and request to Room Service) with an internal action (1820) to deliver to room 1010-B (1818) the champagne to fulfill the guest request.

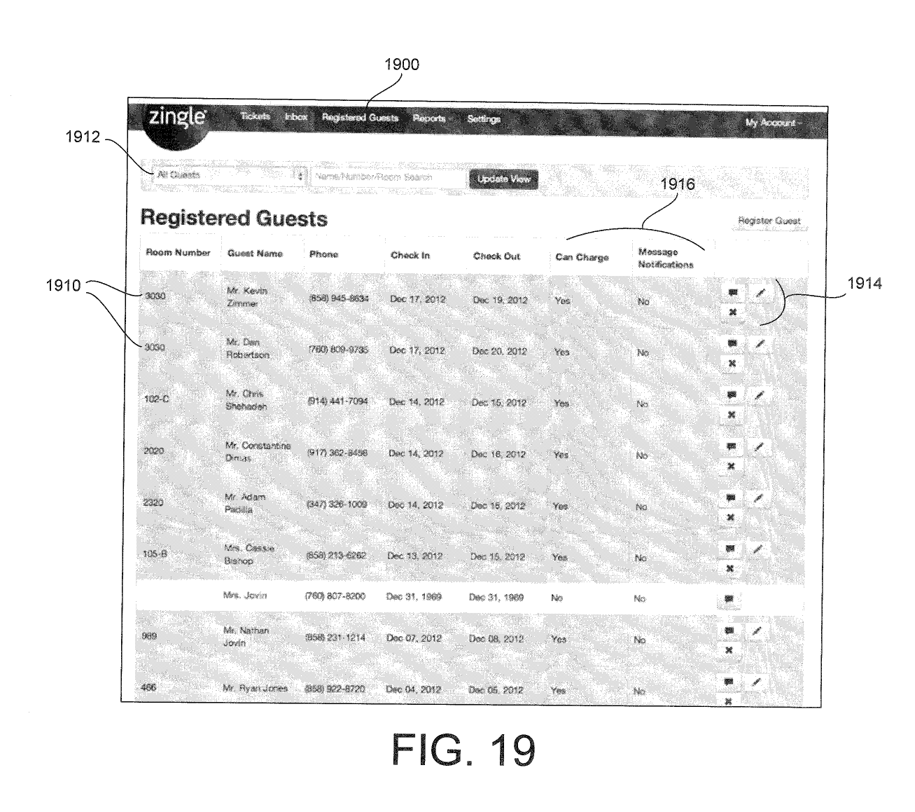

FIG. 19 is a dashboard view 1900 of various registered guests in the hotel and various information about them. As shown, more than one guest may be accounted for in a room (1910). Their check-in and check-out date can also be tracked so that the hotel ACS 100 will understand who is present in the room on various particular dates. For example (1910), in room 3030, two gentlemen are registered to that room. The first man (Mr. Kevin) leaves one day before the second man (Mr. Dan). The ACS 100 can add new guest (1912), remove guests or place notes (1914) along with the profile of each of the hotel customer guests. Information about charging and message notifications (1916) can also be accounted for in the registered guest's user interface dashboard view 1900.

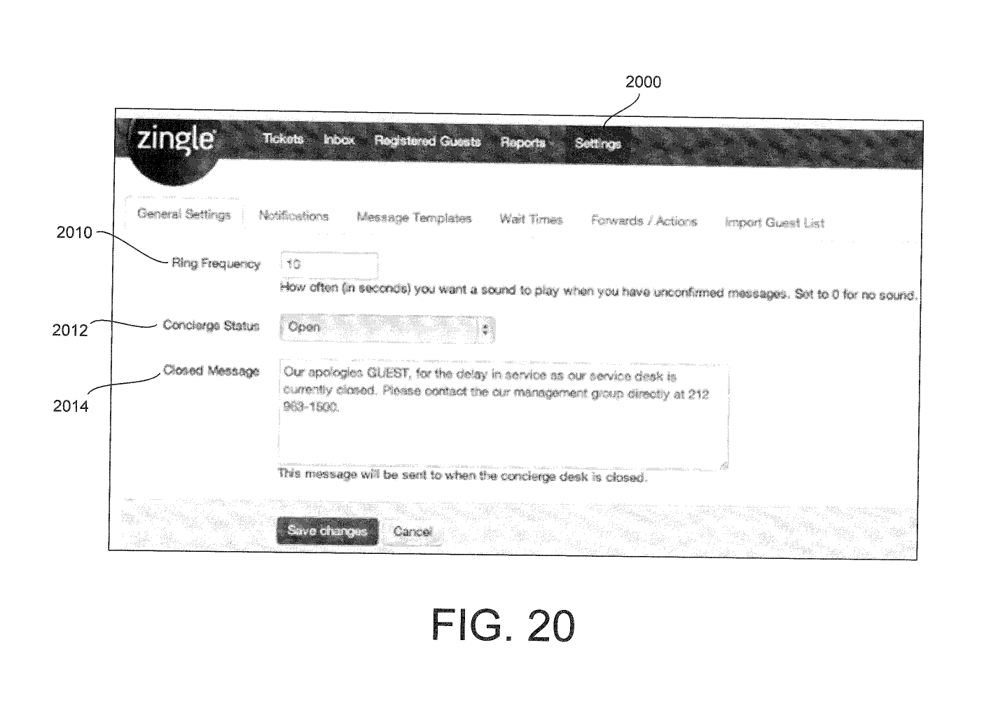

FIG. 20 is a dashboard view 2000 of a general settings pane in a settings tab. Various parameters may be set around the ring frequency (2010) or number of rings that may be permitted when the ACS 100 has unconfirmed messages before the ACS 100 intercepts the message and creates a return message back to the customer.

At box 2012, the concierge status can be set to open or closed. If closed, a closed message (2014) will be sent back to the guest mobile device 220 that the ACS 100 service desk is closed with an alternative for finding help for their request. When a particular department staff or employee is unavailable to perform a customer requested task, the ACS 100 will monitor the incoming request (whether by phone, text message or otherwise) and will notify the hotel guest mobile device 220 that the particular service is unavailable because that particular department is closed. This reply message can be sent back to the customer immediately when the concierge is in a closed status (2012). In this manner, the customer receives an immediate attention for their request and is not waiting for an answer on a closed service to their request. Each of the various actions is logged in the ACS 100 and can be generated in a detailed report about any one or more of its hotel guests.

FIG. 21 is a dashboard view 2100 of a notifications pane in the settings tab that can be monitored by the ACS 100. In these instances, the ACS 100 monitors unanswered messages and the time it took from receipt of the message and the action taken by the ACS 100 in response to the request. Likewise, various notification messages can be preloaded based on the sensitivities of a particular guest.

For example, at row 2110, if a request goes unanswered for 2 minutes, the ACS 100 will notify hotel management that the incoming message from the guest has gone unanswered for 2 minutes, thereby enabling hotel staff to act on the recipients request in a timely manner. In this way, the ACS 100 can ensure prompt attention to an incoming message request from a guest in a timely manner providing for a more efficient stay for the guest with the merchant hotel. Other notifications can be provided, such as to provide an email notification as required at row 2112.

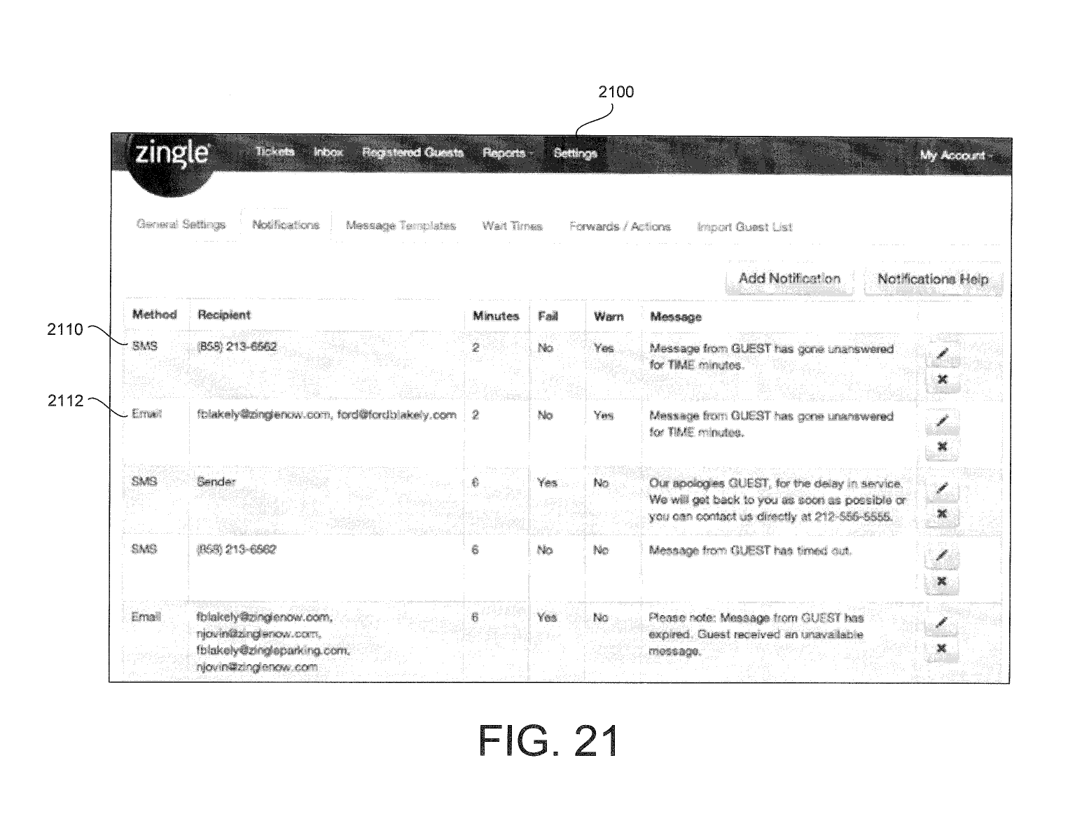

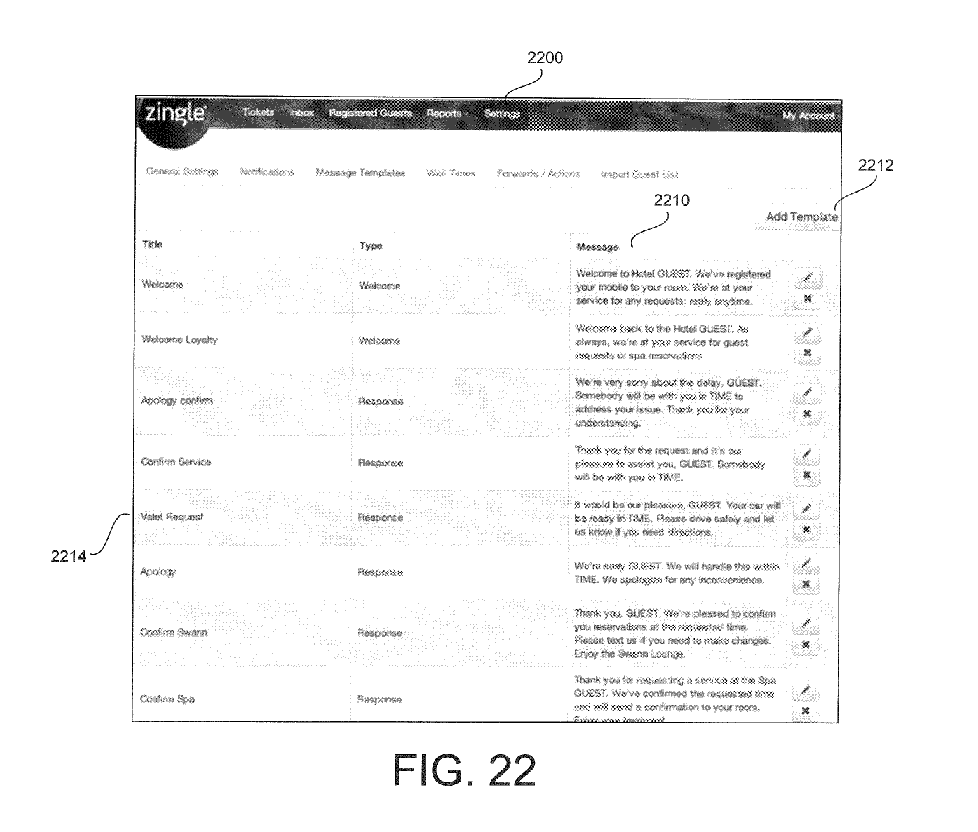

FIG. 22 is a dashboard view 2200 of a message templates pane in the settings tab that can be predefined and selected in the concierge application 120 of the ACS 100. In this way, the hotel merchant can use the concierge application 120 to efficiently and rapidly provide an appropriate response message 2210 back to a guest in response to their incoming message 230 request. Predefining and providing an accepted template for reply messages allows the hotel to establish a sense of uniformity in their response to their guests. Additional message templates can be added to the concierge application 120 by selecting the add template button 2212 and composing a new message template.

Many of these messages can be automatically tied to various predefined workflow processes, such as where an incoming message request is for the valet to bring their car to the lobby. In this instance, the valet response message at row 2214 can be automatically tied to a response for an incoming message 230 request having the keyword “valet” in the incoming message 230 request.

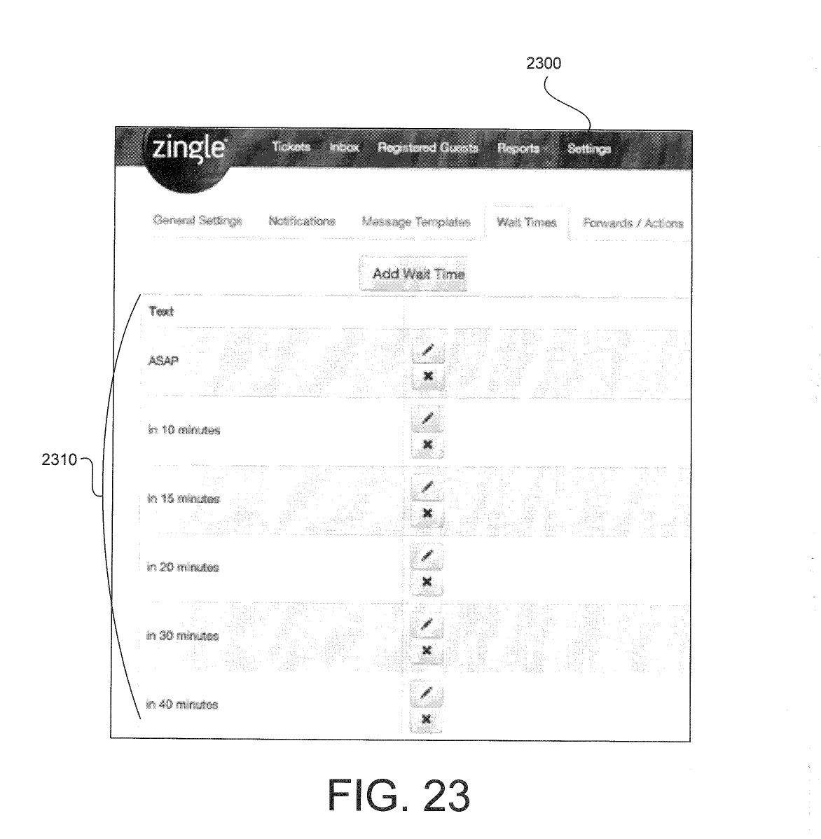

FIG. 23 is a dashboard view 2300 of a wait times template pane in the settings tab that can be predefined and selected in the concierge application 120 of the ACS 100. As before, these various timing choices (2310) can be manually selected by a hotel manager or by the automated virtual concierge application 120 for suitable wait times in response to various incoming message 230 requests. In this manner, the ACS 100 can coordinate, schedule and optimize its use of staff resources to provide the best customer service to its hotel customers. Likewise, the guest can receive a reply message confirming receipt and follow through on the particular request within a predetermined time frame.

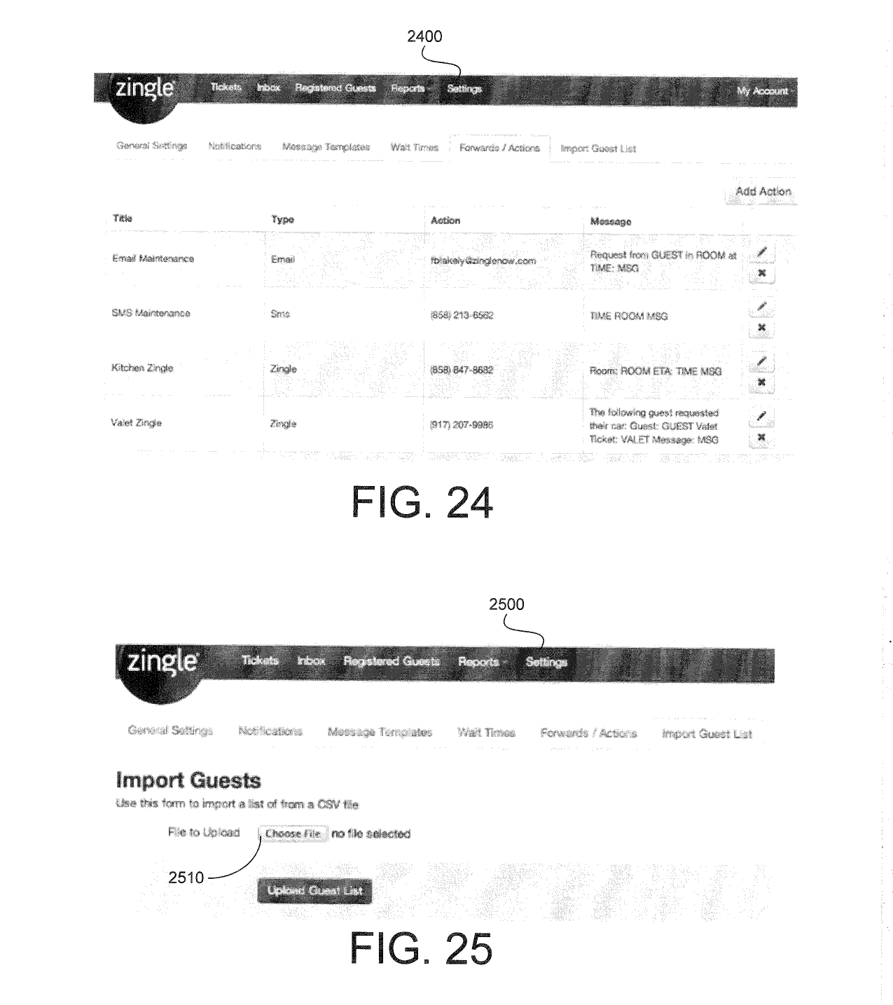

FIG. 24 is a dashboard view 2400 of a forwards/actions templates pane in the settings tab that can be predefined and selected in the concierge application 120 of the ACS 100. Dashboard view 2400 shows various actions that were forwarded and to which of the various departments assigned to handle the request. The detailed report includes various information, such as title of department request was sent, type of message that was forwarded, who the action was taken by, and the message for the action to be taken for the various requests.

FIG. 25 is a dashboard view 2500 of an import guest list pane in the settings tab that can be uploaded into the concierge application 120 of the ACS 100. Dashboard view 2500 demonstrates the ACS 100 in its ability to import various guests at a time into the ACS 100. This advantage allows the ACS 100 to efficiently upload a file list (2510) of guests. This feature is beneficial to import, register and account for a large number of guests all at the same time without the hotel staff having to labor over entering each of the various guests one at a time.

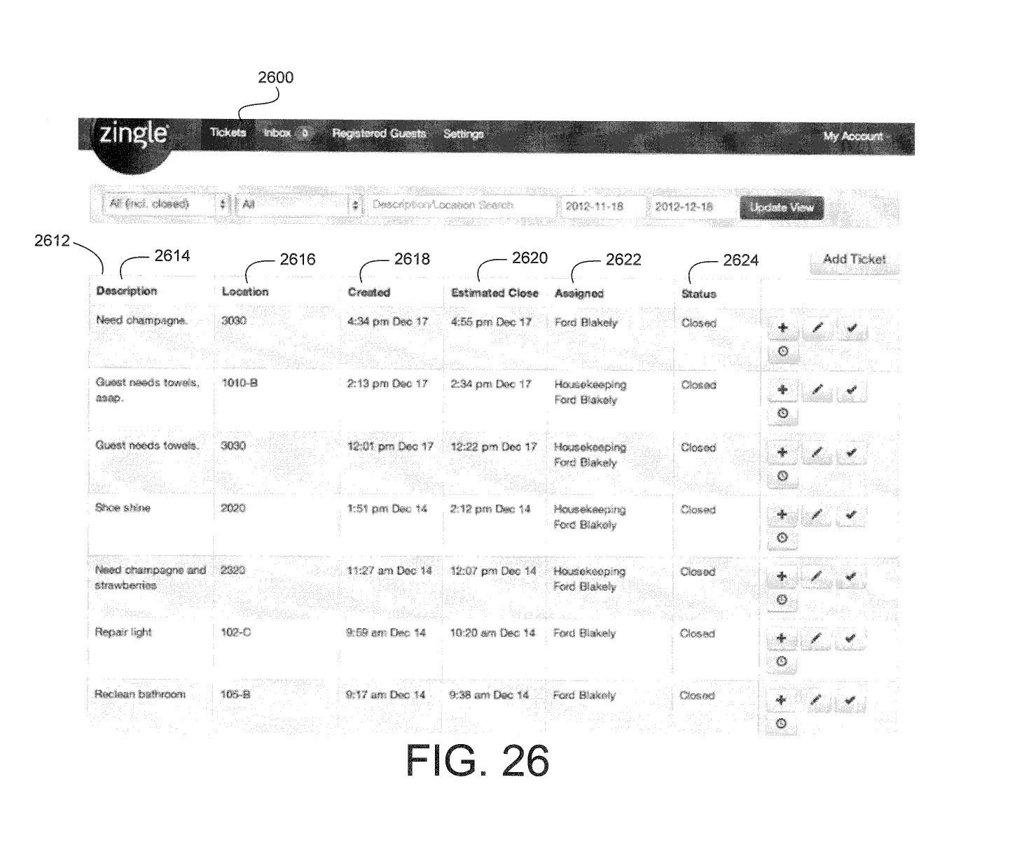

FIG. 26 is a dashboard view 2600 of various tickets 2612 and their status. Dashboard view 2600 shows a report listing various tickets 2612 that have been created on various days by various guests and at different times at the hotel. The ticket 2612 list can be detailed to provide a description 2614 of the request to be performed, the location 2616, the date and time it was created 2618, when the request would be estimated to be closed 2620, who in which department is assigned 2622 to the task and the status 2624 of the request. Likewise, various noted and/or other actions can be logged onto this Tickets user interface.

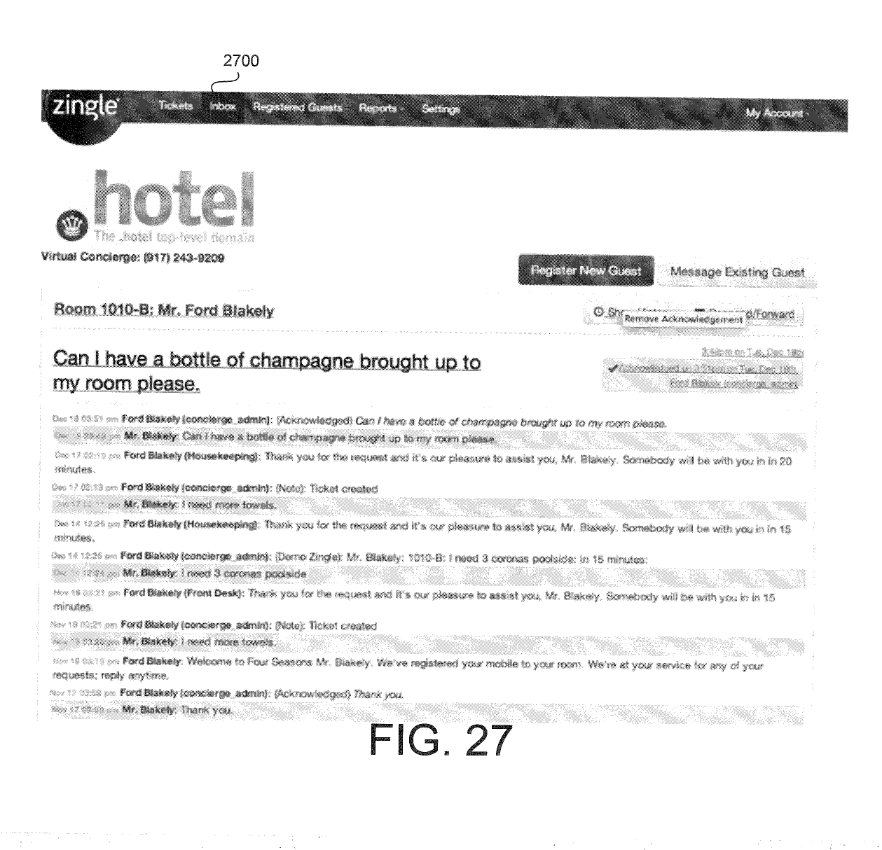

FIG. 27 is a dashboard view 2700 of various incoming message 230 requests received by a guest mobile device 220 of a guest and reply message acknowledgements with an estimated time for fulfillment of the request. Dashboard view 2700 shows various requests that have come from a particular guest. Following each of the various requests are provided reply messages from the concierge application 120 providing the guest with an acknowledgement and an estimated time for fulfillment of the particular request.

In this dashboard view 2700, the various request from the customer in room 1010-B are itemized and various communication between the hotel concierge application 120 and various service departments 130 are logged and saved in the ACS 100 and provided in this dashboard view 2700. This report is convenient and advantageous where the hotel management is trying to review the level of service it has provided to a particular hotel customer using the ACS 100. As with any business and provided by the ACS 100, prompt communication is key to the hotel customer having an enjoyable visiting with the hotel.

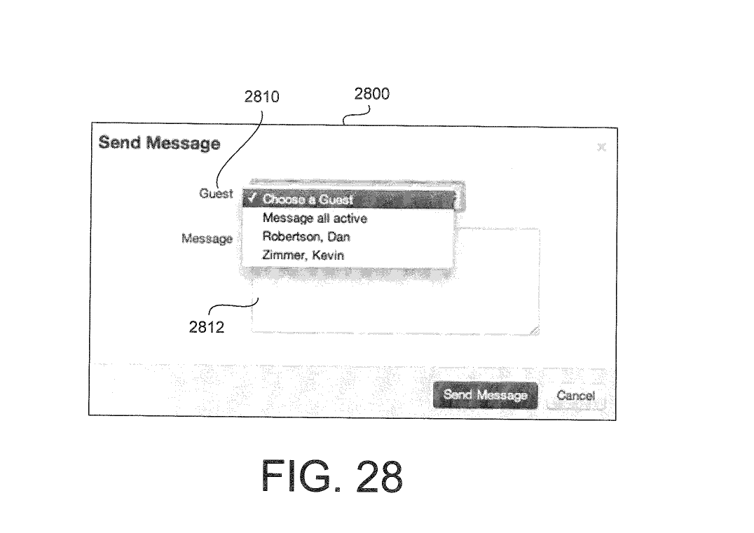

FIG. 28 is a dashboard view 2800 provided with a message composition box 2812 in which the concierge application 120 can be used to generate a reply message and send to a particular hotel guest registered with ACS 100. The various hotel guests can be selected in a convenient manner via a drop down box 2810 or some other suitable method for selecting, composing and sending a message to a hotel guest.

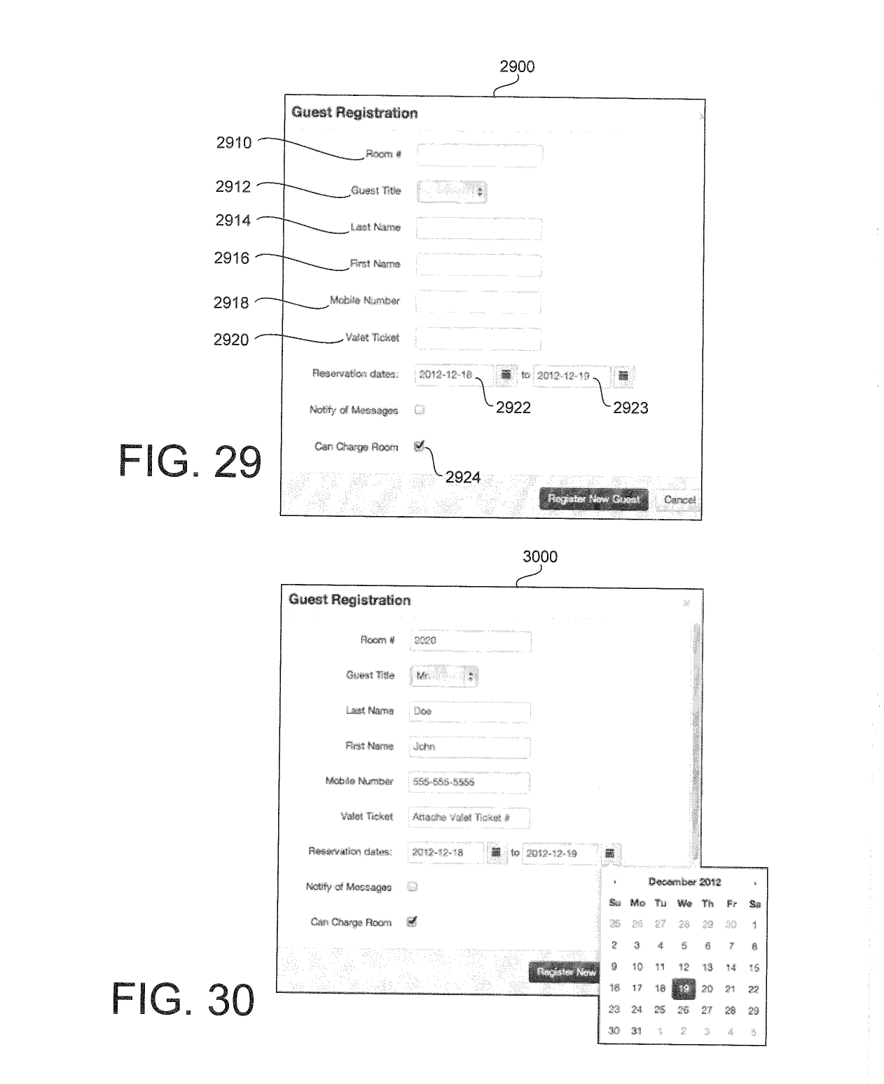

FIGS. 29-30 show dashboard views 2900 (un-filled) and 3000 (filled-in) of a sample Guest Registration template user interface where guest information can be entered and stored by the ACS 100. As before, various drop-down menus 2910-2923 can be incorporated to simplify the entry of the various profile information about the guests, such as room 2910, name 2912-2916, mobile number 2918, valet ticket 2920, arrival and departure reservation dates 2922-2923, notifications 2924 and room charge 2924 preferences. By way of example, FIG. 30 shows the guest registration template filled in with the guest information.

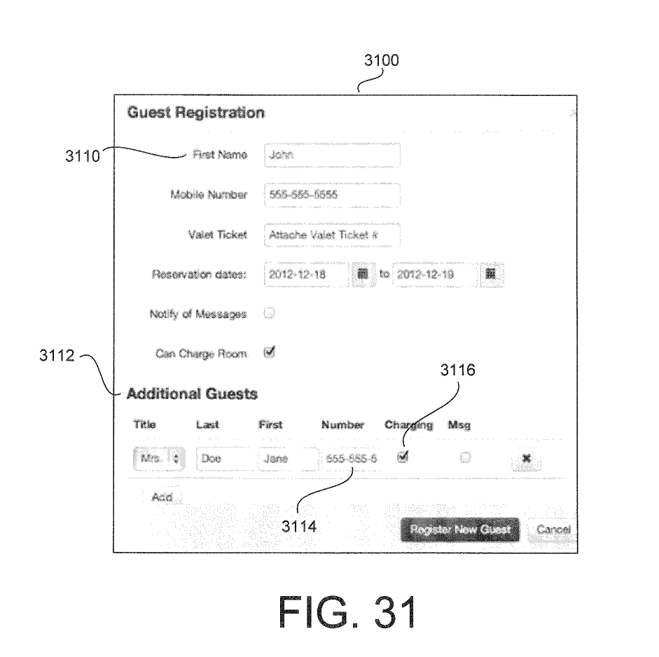

FIG. 31 shows Guest Registration dashboard view 3100 having a portion directed to adding additional guests (Mrs. Jane Doe, 3112) to a primary guest (Mrs. John Doe, 3110) account. Herein, pertinent information about the additional guest 3112 can be added. As before, the additional guest 3112 can be identified by their mobile device number 3114. The additional guest can be authorized to charge 3116 to the primary holders account. Interaction with the additional guest 3112 can be performed as before with the primary hotel guest as described previously.

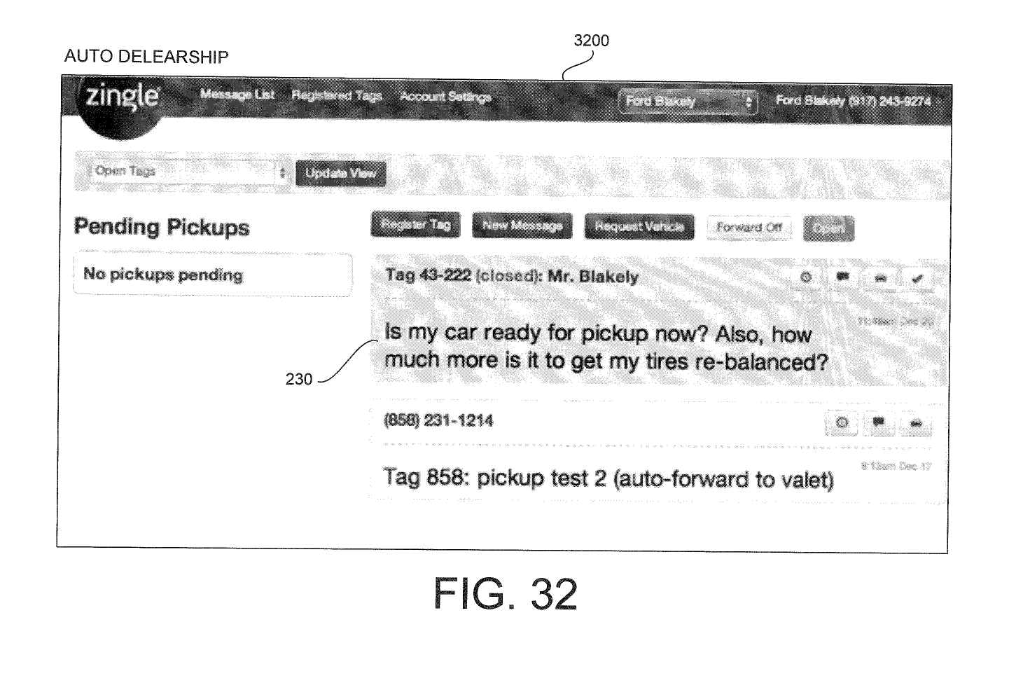

As mentioned above, the ACS 100 can be used for a variety of different services, such as with an automotive dealership as will be described in FIGS. 32-36. It is to be understood that most of the functionality described above is applicable in this automotive dealership embodiment and as such the explanation below will be abbreviated.

FIG. 32 shows a pending pickups dashboard view 3200. In FIG. 32, an automotive customer Mr. Blakely has sent in an incoming message 230 concerning the status of his vehicle and whether additional services can be performed. Various similar identifying profile information is associated with Mr. Blakely for an automotive ACS 100 as would be with the previously described hotel ACS 100. That information would also be received and stored in an automotive computer system (not shown) pertinent to the automotive guest/customer.

In the dashboard view 3200, the automotive ACS 100 is shown managing and responding to the incoming message 230 requests coming in from customers in response to an automotive service inquiry from the customer. Task management and communication back to the customer and to the automotive staff can be provided by ACS 100 in this automotive dealership environment. Similarly, various portable communication devices 131 can also be integrated into various service departments 130 in the automotive ACS 100, such as financing, service, sales, parts, and the like.

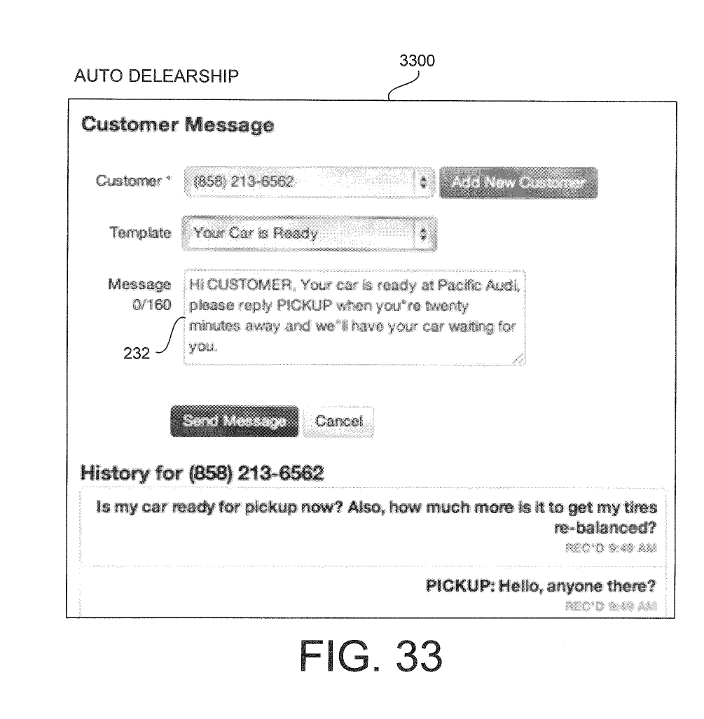

FIG. 33 shows a customer message template dashboard view 3300. In FIG. 33, the automotive ACS 100 creates a reply message 232 back to the automotive customer indicating that the vehicle is ready for pick up. In the reply message 232, the automotive ACS 100 asks the automotive customer to provide a reply at a particular time prior to pick up so that the dealer can prepare for delivery of the vehicle to the automotive customer.

In the alternative, the automotive ACS 100 can be embedded with location based software that can track the guest mobile device 220 of the automotive customer and inform the automotive ACS 100 when the guest mobile device 220 is detected to be approximately 20 mins away from the automotive shop. This feature is beneficial in the service industry where a customer may make an appointment for drop-off or pickup and the customer does not show up as scheduled. Using location based information, such as GPS, triangulation or other location based techniques, the merchant can remain informed as to whether the customer will actually arrive at the scheduled time. If the location based tracking system indicates that the customer is not within a particular distance to the merchants shop that would allow them to meet their scheduled appointment, the automotive ACS 100 can send an alert to the merchant and the customer asking for verification that they will arrive on time and intend on keeping their scheduled appointment. In return, the customer or merchant can modify the arrival time and use their employee resources more efficiently understanding that that particular customer is not going to make it in at their scheduled appointment time. In such an instance, the automotive ACS 100 can schedule another customer in the original customer's appointment time slot.

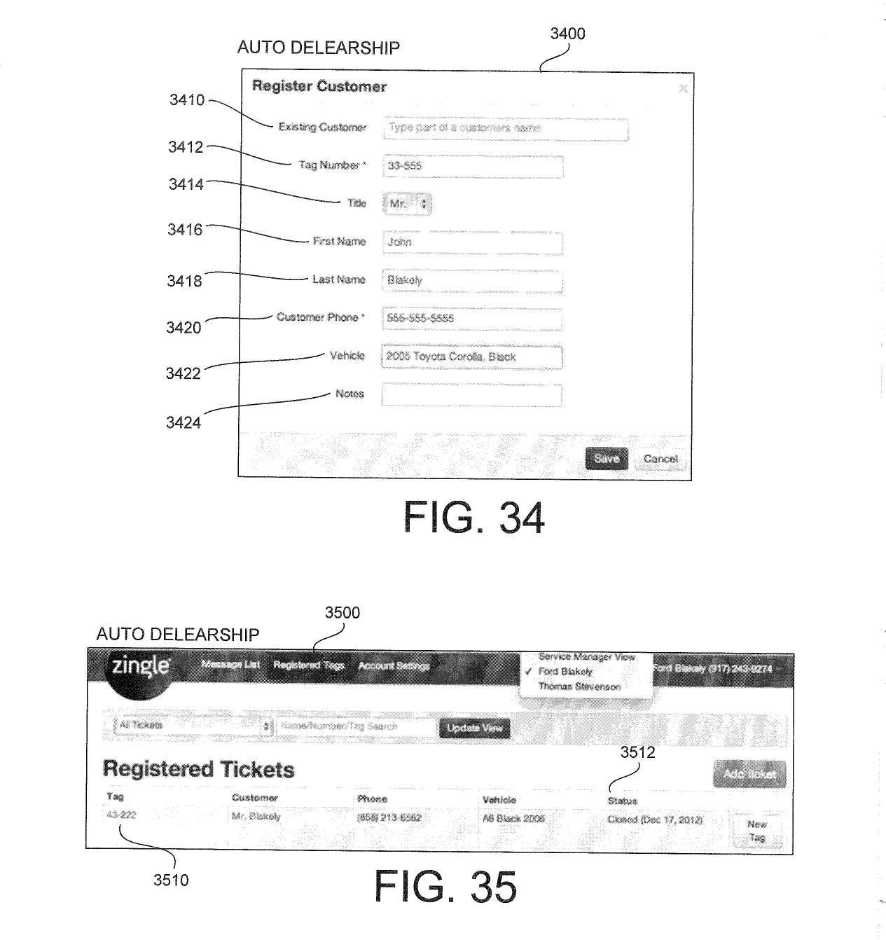

FIG. 34 shows a register customer template dashboard view 3400. In FIG. 34, various types of information may be received about the customer, such as customer name 3410, 3416-3418, tag number of vehicle 3412, phone number 3420, vehicle type 3422 and any pertinent notes 3424. Various other profile information can be provided and collected from the customer.

FIG. 35 shows a registered tickets dashboard view 3500. In FIG. 35, the virtual concierge application 120 or service manager can view the various tickets 3510 and the status 3512 of those various tickets. In this view, the service manager is reviewing Mr. Blakely's ticket 3510 for service and status of the vehicle. Various other types of information can be entered, stored and reviewed about the automotive customers.

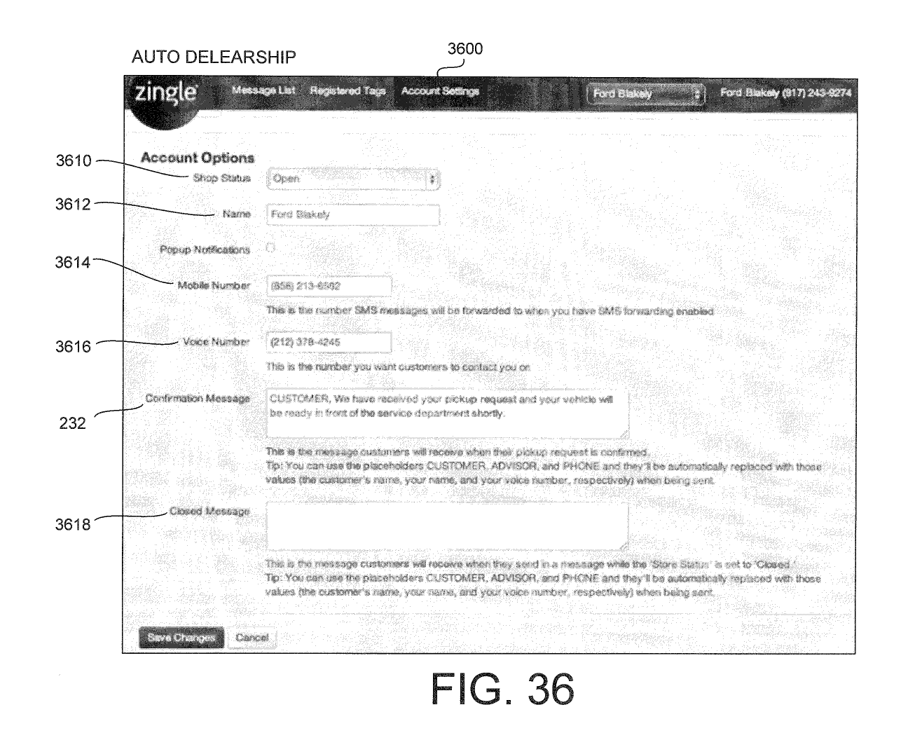

FIG. 36 shows an account settings template dashboard view 3600. In FIG. 36, the automotive ACS 100 provides a user interface in which the automotive merchant can create a reply message 232 back to the automotive customer 3612 via their mobile device 220 phone number 3614. Alternatively, a voice number can be included so that the reply message may be converted via text to voice and left at the customers voice number 3616. The message may indicate that the vehicle is ready and waiting for pickup at a particular location at the merchants' facility. Various other information can be included, such as the shops open status 3610. A primary and alternate phone number can be entered to locate the automotive customer, such as the voice number 3616. In the event that the shop is closed, a closed message 3618 can be provided via a reply message 232 back to the customer.

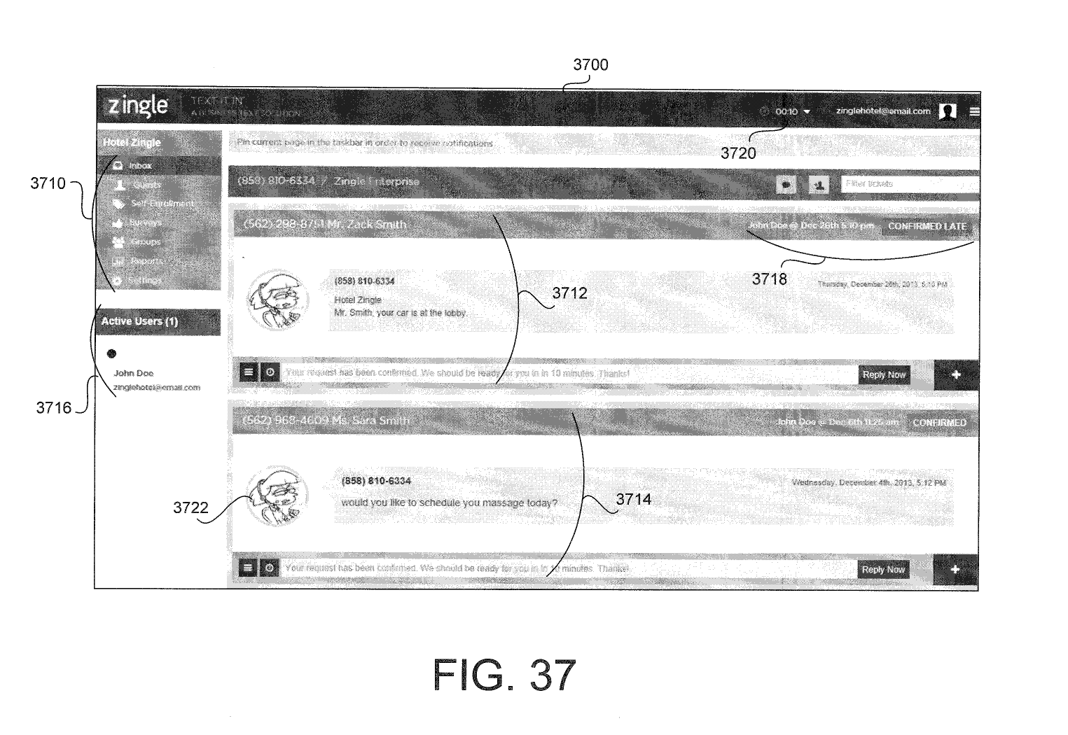

FIGS. 37-40 refer back to the merchant hotel scenario. FIG. 37 illustrates the flexibility with which this concierge application may be rendered on a display at the merchant communication system 50. FIG. 37 is depicts a dashboard view 3700 of an inbox showing various communications from at least two different guests (3712, 3714). Various radio buttons 3710 may be provided conveniently to one side for a merchant user within the dashboard view 3700 to manipulate between various other dashboard views. Section 3718 shows the time stamping which took place by merchant agent John Doe and an indication of whether John Doe was prudent in his response message back to guest which may be set by a timer 3720. The current merchant agent or Active User 3716 is indicated and may embed their own profile picture or avatar at 3722. Likewise, if various other merchant agents were logged into this dashboard they would appear in the Active User 3716 listing. Any other virtual buttons can be embedded into this dashboard interface 3700 to complete various other tasks suitable for an inbox, or the like.

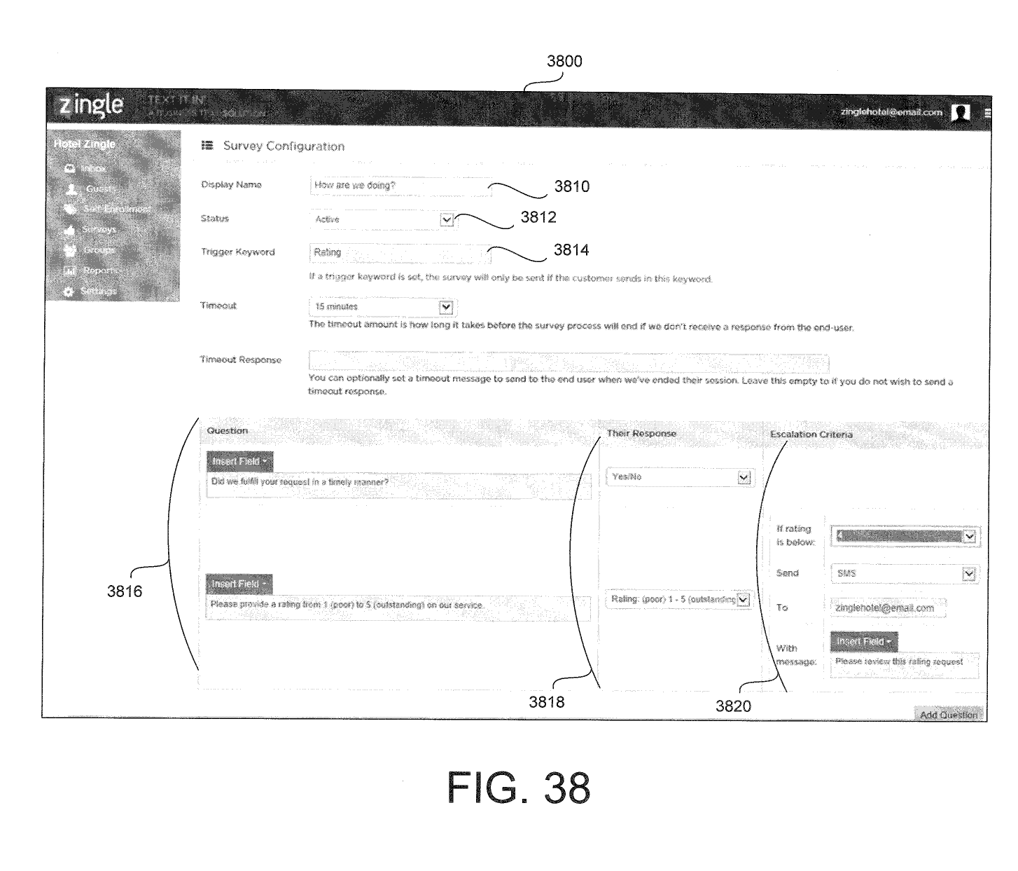

FIG. 38 shows a dashboard view 3800 of a Survey Configuration that may be configured as an automatic work flow. In use, a title for the survey may be provided at 3810, the active status 3812 may be initiated, a trigger or keyword such as “rating” may be embedded to initiate this workflow from a guest mobile device 220. If the survey is not completed within a timeout period 3814 of 15 minutes, the survey may be terminated. In section 3816, various question s and parameters may be configured for this work flow. Their particular responses 3818 can be set up in advance for them to choose from. And, based on the response, various criteria 3820 can be further evaluated. As before with the exemplary workflow in FIGS. 11-13, various types of questions can be asked during the survey and responded to during the workflow.

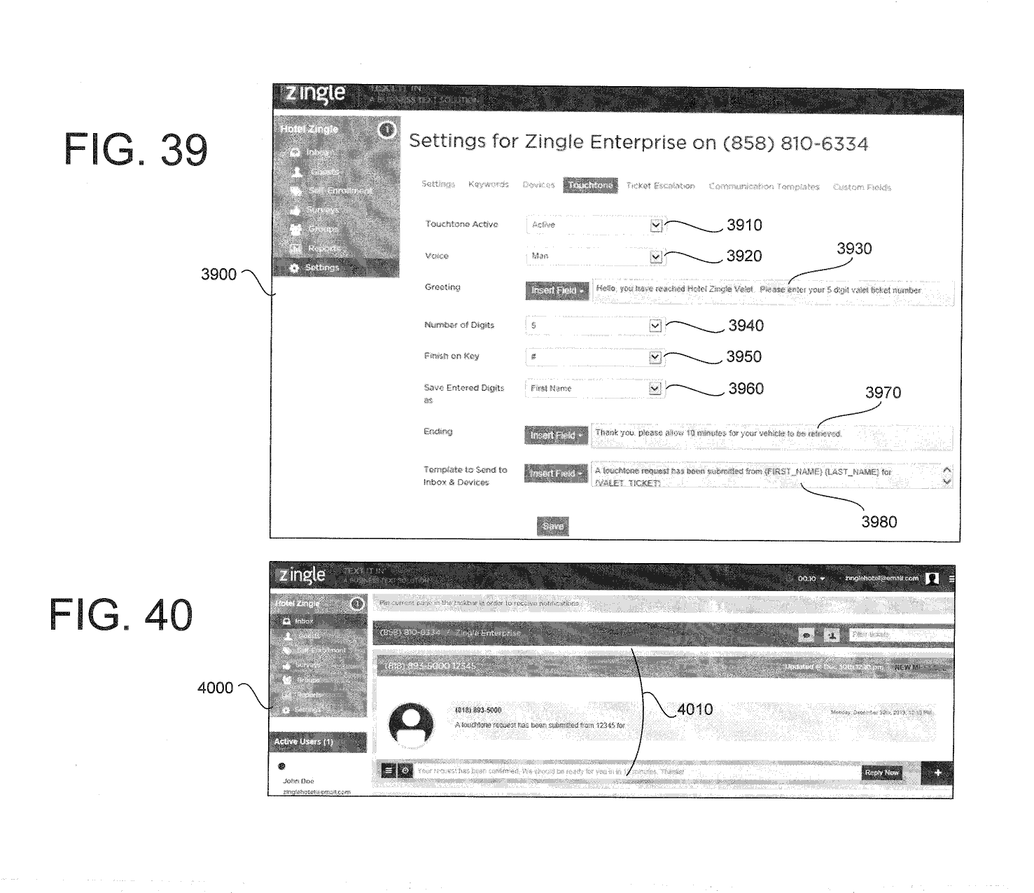

FIGS. 39-40 show dashboard views 3900 and 4000 in which a TouchTone workflow request is made to the ACS 100 and acknowledge back to the guest mobile device 220. In FIG. 39, a touchtone request is set active 3910 and a gender preference is set for the audible voice 3920 message. Once the guest mobile device calls in and/or sends an incoming communication to the 858-810-6334 Enterprise phone number, a workflow for the automated touchtone workflow service is activated. An automated greeting response (3930) automatically asks for the 5 digit (3940) valet ticket number. Once the last number (3950) is transmitted to the ACS 100, the valet number is automatically saved with the associated name of the guest mobile device user and a request to have their vehicle brought to the lobby is automatically initiated. The incoming request is automatically forwarded to the valet 136 so that the hotel valet employee can fetch the vehicle and bring it to the lobby.

What has been described above includes examples of the subject matter. It is, of course, not possible to describe every conceivable combination of components or methodologies for purposes of describing the claimed subject matter, but one of ordinary skill in the art can recognize that many further combinations and permutations of such matter are possible. Accordingly, the subject matter is intended to embrace all such alterations, modifications and variations that fall within the spirit and scope of this subject disclosure.

What is claimed is:

1. An automated concierge system that coordinates requested services between wireless device customers and a merchant computer system over an unused control channel, the system comprising:
a concierge server that receives incoming message requests for service from a wireless device; and
a concierge application resident on the concierge server, the concierge application configured to:
receive an incoming message from the wireless device for a requested service;
send, in response to the incoming message a reply message acknowledging receipt of the incoming message to the wireless device; and
notifying the merchant computer system of the incoming message request.

2. The system recited in claim 1, wherein when the incoming message to the concierge application is from an authenticated and previously registered wireless device user, the incoming message includes identifying registration information about the wireless device user.

3. The system recited in claim 2, wherein the identifying registration information includes the wireless device user phone number or name.

4. The system recited in claim 1, wherein if the request for service is not completed in a predetermined period of time, the concierge application will send a notification message to a merchant computer system notifying the merchant that the request has been unfulfilled.

5. The system recited in claim 1, wherein the incoming message is assigned and forwarded by the concierge application for the requested service to a service department terminal within the merchant computer system.

6. The system recited in claim 5, wherein all communications between the concierge server, the service department terminal and the wireless device are sent and received over an unused control channel by SMS.

7. The system recited in claim 1, wherein all communications to and from the concierge server are sent and received over an unused control channel by SMS.

8. The system recited in claim 5, wherein the service department terminal receives the incoming message directly from the wireless device and a copy of the incoming message is forwarded to the concierge server.

9. The system recited in claim 1, wherein the automated concierge system includes a modem through which all communications, in and out, are communicated via SMS.

10. The system recited in claim 1, wherein the concierge application logs all communications related to the requested service in a central database.

11. The system recited in claim 1, wherein a portion of the concierge application is resident on the merchant computer system.

12. The system recited in claim 1, wherein the incoming message contains a keyword that initiates an automatic workflow routine to register a wireless device user with the concierge server as a new customer, and
wherein the workflow routine generates a series of SMS questions to which the wireless device responds by SMS back to the concierge sever, responding to each of the questions until the questions are fulfilled and the workflow routine is completed.

13. An automated concierge system that coordinates requested services between wireless device customers and a merchant over an unused control channel, the system comprising:
a concierge server that receives incoming message requests for service from a wireless device; and
a concierge application resident on the concierge server, the concierge application configured to:
receive an incoming message from the wireless device for a requested service;
send, in response to the incoming message a reply message acknowledging receipt of the incoming message to the wireless device; and
analyze the incoming message to determine if a keyword is included in the incoming message that initiates an automated workflow routine.

14. The system recited in claim 13, wherein if the incoming message contains the keyword, the automatic workflow routine initiated is to register a wireless device user with the concierge server as a new customer, and
wherein the workflow routine generates a series of SMS questions to which the wireless device responds by SMS back to the concierge sever, responding to each of the questions until the questions are fulfilled and the workflow routine is completed.

15. The system recited in claim 13, wherein the automatic workflow routine generates a series of SMS questions to which the wireless device responds by SMS back to the concierge sever, responding to each of the questions until the questions are fulfilled and the workflow routine is completed.

16. A method for coordinating requested services between wireless device customers and a merchant computer system over an unused control channel, the method comprising:
receiving incoming message requests for service from a wireless device at a concierge server; and
providing a concierge application on the concierge server, the concierge application further comprising:
receiving an incoming message from the wireless device for a requested service;
acknowledging, by sending in response to the incoming message a reply message of receipt of the incoming message to the wireless device;
analyze the incoming message to determine if a keyword is included in the incoming message; and
initiating an automated workflow routine defined by the keyword.

17. The method recited in claim 16, further comprising:
generating a series of SMS questions and sending to the wireless device; and
receiving a series of responses from the wireless device responding to the questions until the questions are fulfilled and the workflow routine is completed.

18. The method recited in claim 16, further comprising:
automatically registering the wireless device customer by automatically asking for registration information from the wireless device customer in a series of question, to which the wireless device customer replies via their wireless device until all of the parameters of the workflow routine are completed, and then automatically authenticating the wireless device for use on an automated concierge system.

19. The method recited in claim 16, further comprising:
forwarding the incoming message to a service department terminal in the merchant computer system to fulfill the request.
